(19) United States
(12) Patent Application Publication
(10) Pub. No.: US 2025/0337552 A1
(43) Pub. Date: Oct. 30, 2025

(54) CAMPING IN A CELL

(71) Applicant: Samsung Electronics Co., Ltd., Suwon-si (KR)

(72) Inventors: Anil Agiwal, McKinney, TX (US); Kyeongin Jeong, Allen, TX (US); Shiyang Leng, Little Elm, TX (US)

(21) Appl. No.: 19/172,550

(22) Filed: Apr. 7, 2025

Related U.S. Application Data
(60) Provisional application No. 63/640,025, filed on Apr. 29, 2024.
(60) Provisional application No. 63/641,129, filed on May 1, 2024.
(60) Provisional application No. 63/676,113, filed on Jul. 26, 2024.

(51) Int. Cl. H04L 5/00; H04W 48/08; H04W 72/0453; H04W 72/231

(52) U.S. Cl. CPC H04L 5/0094; H04L 5/0053; H04W 48/08; H04W 72/0453; H04W 72/231

(57) ABSTRACT

A method of operating a user equipment (UE) includes receiving a master information block (MIB) of a first cell on a carrier frequency belonging to a first frequency range (FR1). The method also includes, determining a first subcarrier offset (K_{SSB}) based on ssb-SubcarrierOffset information in the MIB received on the carrier frequency belong to FR1, determining whether the first K_{SSB} is greater than or equal to 24, and determining whether the UE has a system information block 1 (SIB1) request configuration of the first cell. The method also includes, in response to a determination that the first K_{SSB} is greater than or equal to 24 and a determination that the UE has the SIB1 request configuration of the first cell, transmitting, to the first cell, a request for the SIB1 of the first cell.

### CROSS-REFERENCE TO RELATED APPLICATIONS AND CLAIM OF PRIORITY

This application claims priority un 35 U.S.C. § 119(e) to U.S. Provisional Patent Application No. 63/640,025 filed on Apr. 29, 2024, U.S. Provisional Patent Application No. 63/641,129 filed on May 1, 2024, and U.S. Provisional Patent Application 63/676,113 filed on Jul. 26, 2024. The above-identified provisional patent applications are hereby incorporated by reference in their entirety.

### TECHNICAL FIELD

This disclosure relates generally to wireless networks. More specifically, this disclosure relates to camping in a cell.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for camping in a cell.

In one embodiment, a user equipment (UE) is provided. The UE includes a transceiver. The transceiver is configured to receive a master information block (MIB) of a first cell on a carrier frequency belonging to a first frequency range (FR1). The UE also includes a processor operably coupled to the transceiver. The processor is configured to determine a first subcarrier offset (S_{SB}) based on ssb-SubcarrierOffset information in the MIB received on the carrier frequency belonging to FR1, determine whether the first K_{SSB} is greater than or equal to 24, and determine whether the UE has a system information block 1 (SIB1) request configuration of the first cell. The processor is also configured to, in response to a determination that the first KSSB is greater than or equal to 24 and a determination that the UE has the SIB1 request configuration of the first cell, cause the transceiver to transmit, to the first cell, a request for the SIB1 of the first cell.

In another embodiment, a base station (BS) is provided. The BS includes a processor, and a transceiver operably coupled to the processor. The transceiver is configured to transmit, in a first cell in which the BS is operating, a master information block (MIB) for the first cell. The MIB for the first cell includes ssb-SubcarrierOffset information. The transceiver is also configured to receive, from a UE, a request for a system information block 1 (SIB1) for the first cell, transmit, to the UE, an acknowledgment of the request for the SIB1 for the first cell, and transmit, in the first cell, the SIB1 for the first cell.

In yet another embodiment, a method of operating a UE is provided. The method includes receiving a MIB of a first cell on a carrier frequency belonging to FR1. The method also includes determining a K_{SSB} based on ssb-SubcarrierOffset information in the MIB received on the carrier frequency belonging to FR1, determining whether the first K_{SSB} is greater than or equal to 24, and determining whether the UE has a SIB1 request configuration of the first cell. The method also includes, in response to a determination that the first K_{SSB} is greater than or equal to 24 and a determination that the UE has the SIB1 request configuration of the first cell, transmitting, to the first cell, a request for the SIB1 of the first cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for cell reselection according to embodiments of the present disclosure;

FIG. 5 illustrates another example procedure for cell reselection according to embodiments of the present disclosure;

FIG. 6 illustrates another example procedure for cell reselection according to embodiments of the present disclosure;

FIG. 7 illustrates another example procedure for cell reselection according to embodiments of the present disclosure;

FIG. 8 illustrates an example procedure for SIB1 acquisition according to embodiments of the present disclosure

FIG. 9 illustrates a graph showing example offsets according to embodiments of the present disclosure;

FIG. 10 illustrates an example method for SIB1 acquisition according to embodiments of the present disclosure;

FIG. 11 illustrates another example method for SIB1 acquisition according to embodiments of the present disclosure; and

FIG. 12 illustrates another example method for SIB1 acquisition according to embodiments of the present disclosure.

### DETAILED DESCRIPTION

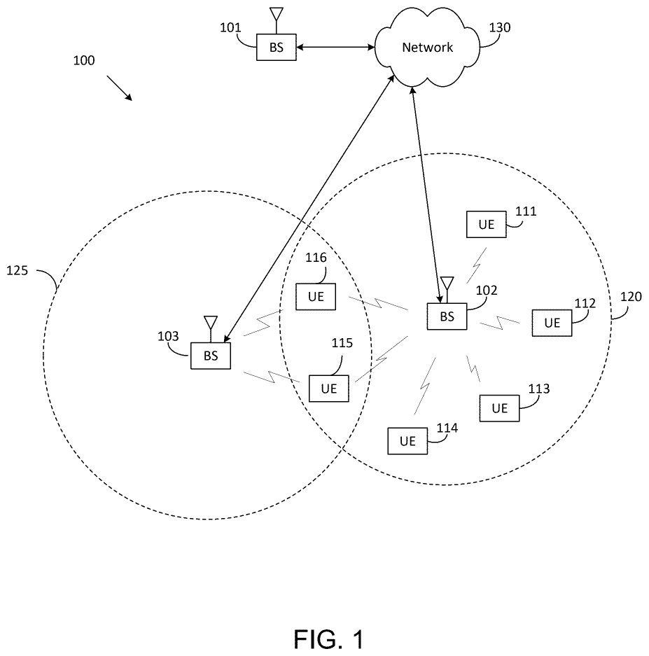

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for camping in a cell. In certain embodiments, one or more of the gNBs 101-103 includes circuitry, programing, or a combination thereof, to support camping in a cell in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

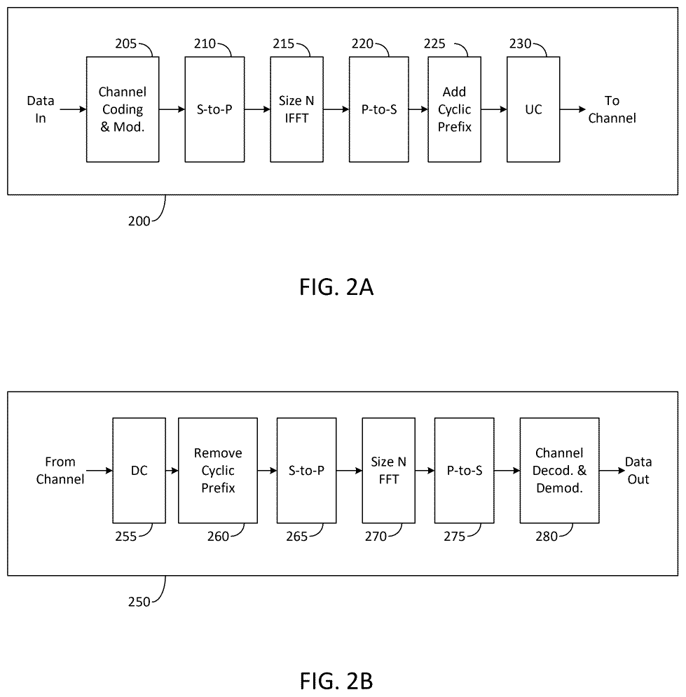

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support camping in a cell as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

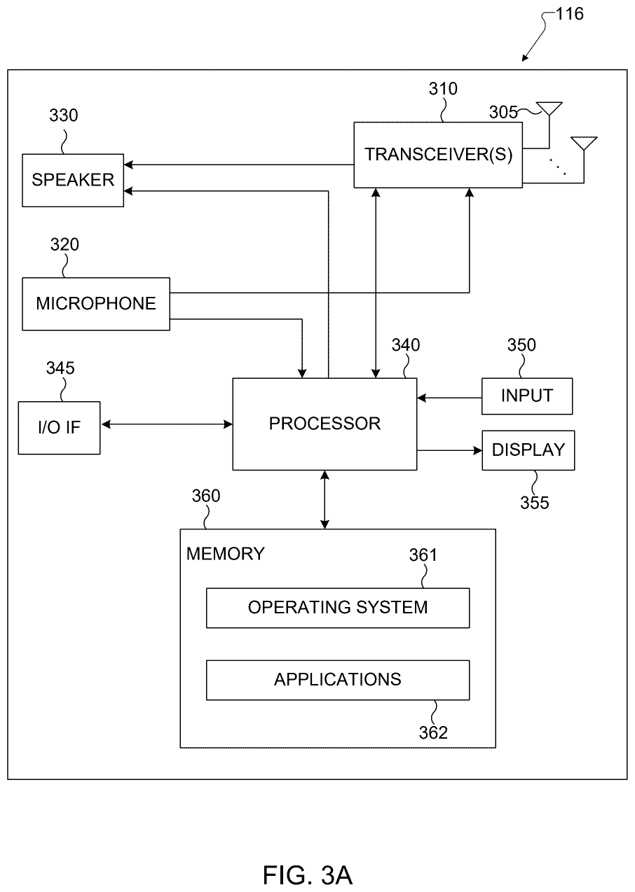

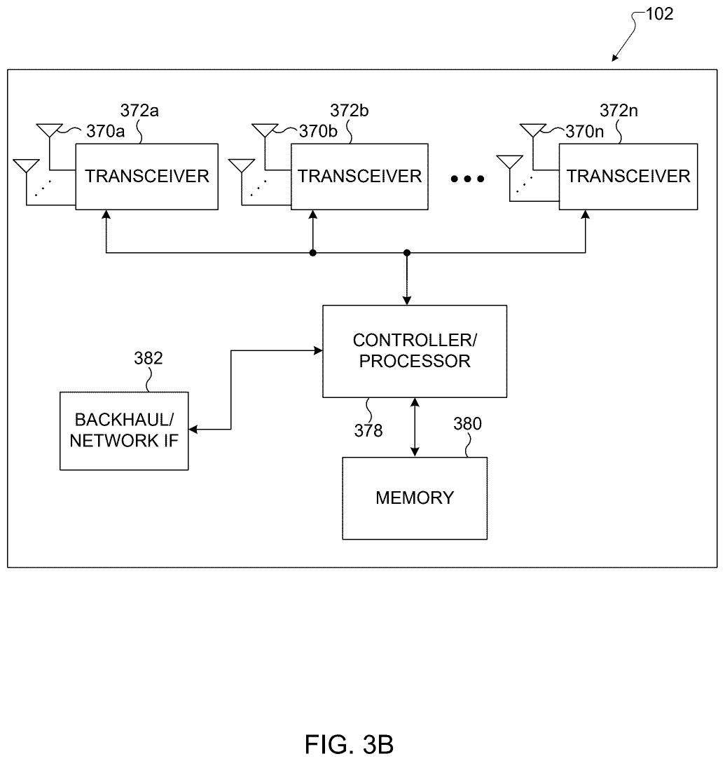

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for camping in a cell as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support camping in a cell as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell as each narrow TX beam provides coverage to a part of cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR PCell refers to a serving cell in a MCG, operating on the primary frequency, in which the UE either performs the initial connection establishment procedure or initiates the connection re-establishment procedure. In NR for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG, otherwise the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of system information blocks (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and positioning SIBs (posSIBs) are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get SFN timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in RRC CONNECTED state. Several types of RA procedures are supported, such as contention based random access, and contention free random access. Each of these can be one of 2 step or 4 step random access.

In the next generation wireless communication system (e.g., 5G, beyond 5G, 6G). A physical downlink control channel (PDCCH) is used to schedule DL transmissions on a physical downlink shared channel (PDSCH) and UL transmissions on a physical uplink shared channel) PUSCH, where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL RS ID (SSB or CSI RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is QCLed with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-Inactivity Timer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured). In the RRC IDLE and RRC INACTIVE states, the UE transmits/receives to/from the gNB on the initial Uplink BWP and initial DL BWP respectively. For a reduced capacity (RedCap) UE, the initial Uplink BWP and initial DL BWP for the RedCap UE can be optionally configured, which is used by RedCap UE, if configured.

In the next generation wireless communication system (e.g., 5G, beyond 5G, 6G), a UE can reselect to another cell on the same frequency as the frequency of the currently camped cell or another cell on a frequency different from the frequency of the currently camped cell but having the same frequency priority as the frequency priority of the currently camped cell, based on following procedure.

The UE shall perform ranking of all cells that fulfill the cell selection criterion “S” (shown below). The cells shall be ranked according to the “R” criteria (shown below) by deriving Q_{meas,n} and Q_{meas,s} and calculating the R values using averaged RSRP results.

If rangeToBestCell is not configured, the UE shall perform cell reselection to the highest ranked cell provided that access to that cell is not restricted as per cell access criteria.

If rangeToBestCell is configured, then the UE shall perform cell reselection to the cell with the highest number of beams above the threshold (i.e., absThreshSS-BlocksConsolidation) among the cells whose R value is within rangeToBestCell of the R value of the highest ranked cell provided that access to that cell is not restricted as per cell access criteria. If there are multiple such cells, the UE shall perform cell reselection to the highest ranked cell among them, provided that access to that cell is not restricted as per cell access criteria.

In all cases, the UE shall reselect the new cell, only if the following conditions are met:
the new cell is better than the serving cell according to the cell reselection criteria specified above during a time interval Treselection_{RAT};
more than 1 second has elapsed since the UE camped on the current serving cell.

### R Criteria

The cell-ranking criterion Rₛ for the serving cell and Rₙ for neighboring cells is defined by:

$${R}_{s} = {Q}_{meas , s} + {Q}_{h y s t} - {Qoffset}_{t e m p}$$

$${R}_{n} = {Q}_{meas , n} - Qoffset - {Qoffset}_{t e m p}$$

where:

TABLE 1

| | |
|---|---|
| Qₘₑₐₛ | RSRP measurement quantity used in cell |
| | reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell for |
| | connEstFailOffsetValidity duration if the connection |
| | establishment has failed on this cell |
| | connEstFailCount times |

### Cell Selection Criterion S

The cell selection criterion S is fulfilled when:
Srxlev>0 AND Squal>0
   where:

$$Srxlev = {Q}_{rxlevmeas} - ( {Q}_{rxlevmin} + {Q}_{rxlevminoffset} ) - {P}_{compensation} - {Qoffset}_{t e m p}$$

$$Squal = {Q}_{qualmeas} - ( {Q}_{qualmin} + {Q}_{qualminoffset} ) - {Qoffset}_{t e m p}$$

where:

TABLE 2

| | |
|---|---|
| Srxlev | Cell selection RX level value (dB) |
| Squal | Cell selection quality value (dB) |
| Qoffsetₜₑₘₚ | Offset temporarily applied to a cell for connEstFailOffsetValidity duration |
| | if the connection establishment has failed on this cell connEstFailCount |
| | times |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL |
| | frequency for this cell, Qᵣₓₗₑᵥₘᵢₙ is obtained from q-RxLevMinSUL, if |
| | present, in SIB1, SIB2 and SIB4, additionally, if Q_{rxlevminoffsetcellSUL} is |
| | present in SIB3 and SIB4 for the concerned cell, this cell specific offset is |
| | added to the corresponding Qrxlevmin to achieve the required minimum |
| | RX level in the concerned cell; |
| | else Qᵣₓₗₑᵥₘᵢₙ is obtained from q-RxLevMin in SIB1, SIB2 and SIB4, |
| | additionally, if Q_{rxlevminoffsetcell} is present in SIB3 and SIB4 for the |
| | concerned cell, this cell specific offset is added to the corresponding |
| | Qrxlevmin to achieve the required minimum RX level in the concerned |
| | cell. |
| Q_{qualmin} | Minimum required quality level in the cell (dB). Additionally, if |
| | Q_{qualminoffsetcell} is signalled for the concerned cell, this cell specific offset is |
| | added to achieve the required minimum quality level in the concerned |
| | cell. |
| Q_{rxlevminoffset} | Offset to the signaled Qᵣₓₗₑᵥₘᵢₙ taken into account in the Srxlev evaluation |
| | as a result of a periodic search for a higher priority PLMN while camped |
| | normally in a VPLMN. |
| Q_{qualminoffset} | Offset to the signaled Q_{qualmin} taken into account in the Squal evaluation as |
| | a result of a periodic search for a higher priority PLMN while camped |
| | normally in a VPLMN. |
| P_{compensation} | For FR1, if the UE supports the additionalPmax in the NR-NS-PmaxList, |
| | if present, in SIB1, SIB2 and SIB4: |
| | max(P_{EMAX1} − P_{PowerClass}, 0) − (min(P_{EMAX2}, P_{PowerClass}) − min(P_{EMAX1}, |
| | P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power level of a UE may use when transmitting on the |
| | uplink in the cell (dBm) defined as P_{EMAX}. If UE supports SUL frequency |
| | for this cell, P_{EMAX1} and P_{EMAX2} are obtained from the p-Max for SUL in |
| | SIB1 and NR-NS-PmaxList for SUL respectively in SIB1, SIB2 and SIB4, |
| | else P_{EMAX1} and P_{EMAX2} are obtained from the p-Max and NR-NS- |
| | PmaxList respectively in SIB1, SIB2 and SIB4 for normal UL. |
| P_{PowerClass} | Maximum RF output power of the UE (dBm) according to the UE power |
| | class |

The signaled values Q_{rxlevminoffset} and Q_{qualminoffset} are only applied when a cell is evaluated for cell selection as a result of a periodic search for a higher priority public land mobile network (PLMN) while camped normally in a visited PLMN (VPLMN). During this periodic search for a higher priority PLMN, the UE may check the S criteria of a cell using parameter values stored from a different cell of this higher priority PLMN.

In the next generation wireless communication system (e.g., 5G, beyond 5G, 6G). A UE can reselect to another cell on a frequency different from the frequency of the currently camped cell but having a different frequency priority than the frequency priority of the currently camped cell, based on following procedure.

If threshServingLowQ is broadcast in system information and more than 1 second has elapsed since the UE camped on the current serving cell, cell reselection to a cell on a higher priority NR frequency or inter-radio access technology (RAT) frequency than the serving frequency shall be performed if:
A cell of a higher priority NR or EUTRAN RAT/frequency fulfills Squal>Thresh_{X, HighQ} during a time interval Treselection_{RAT}.

Otherwise, cell reselection to a cell on a higher priority NR frequency or inter-RAT frequency than the serving frequency shall be performed if:
A cell of a higher priority RAT/frequency fulfills Srxlev>Thresh_{X, HighP} during a time interval Treselection_{RAT}; and
More than 1 second has elapsed since the UE camped on the current serving cell.

If threshServingLowQ is broadcast in system information and more than 1 second has elapsed since the UE camped on the current serving cell, cell reselection to a cell on a lower priority NR frequency or inter-RAT frequency than the serving frequency shall be performed if:
The serving cell fulfills Squal<Thresh_{Serving, LowQ} and a cell of a lower priority NR or E-UTRAN RAT/frequency fulfills Squal>Thresh_{X, LowQ} during a time interval Treselection_{RAT}.

Otherwise, cell reselection to a cell on a lower priority NR frequency or inter-RAT frequency than the serving frequency shall be performed if:
The serving cell fulfills Srxlev<Thresh_{Serving, LowP} and a cell of a lower priority RAT/frequency fulfills Srxlev>Thresh_{X, LowP} during a time interval Treselection_{RAT}; and
More than 1 second has elapsed since the UE camped on the current serving cell.

Cell reselection to a higher priority RAT/frequency shall take precedence over a lower priority RAT/frequency if multiple cells of different priorities fulfill the cell reselection criteria.

If more than one cell meets the above criteria, the UE shall reselect a cell as follows:
If the highest-priority frequency is an NR frequency, the highest ranked cell among the cells on the highest priority frequency(ies) meeting the criteria as defined for intra-frequency and equal priority inter-frequency cell reselection criteria in the wireless communication system;
If the highest-priority frequency is from another RAT, the strongest cell among the cells on the highest priority frequency(ies) meeting the criteria of that RAT.

The UE can reselect to a cell determined above only if access to that cell is not restricted as per cell access criteria. Also, when evaluating Srxlev and Squal of non-serving cells for reselection evaluation purposes, the UE shall use parameters provided by the serving cell and for the final check on cell selection criterion, the UE shall use parameters provided by the target cell for cell reselection.

Access to a cell is not allowed if the cell is not suitable due to one or more of the following reasons:
this cell belongs to a PLMN which is not indicated as being equivalent to the registered PLMN, or
this cell is a closed access group (CAG) cell that belongs to a PLMN which is equivalent to the registered PLMN but with no CAG-ID that is present in the UE's allowed CAG list being broadcasted, or
this cell is not a CAG cell and the CAG-only indication in the UE is set, or
this cell does not belong to a standalone non-public network (SNPN) that is equal to the registered or selected SNPN of the UE in SNPN access mode.

Access to a cell is not allowed if the cell is considered as barred based on following: Cell status and cell reservations are indicated in the MIB or SIB1 message by means of the following fields:
cellBarred (IE type: “barred” or “not barred”)
Indicated in a MIB message. In case of multiple PLMNs or non-public networks (NPNs) indicated in SIB1, this field is common for all PLMNs and NPNs. This field is ignored by UEs supporting non-terrestrial networks (NTNs) while cellBarredNTN is included in SIB1.
cellBarredNTN (IE type: “barred” or “not barred”)
Indicated in a SIB1 message. In case of multiple PLMNs indicated in SIB1, this field is common for all PLMNs. This field is ignored if the UE does not support NTN connectivity.
cellBarredRedCap1Rx (IE type: “barred” or “not barred”)
Indicated in a SIB1 message. In case of multiple PLMNs or NPNs indicated in SIB1, this field is common for all PLMNs and NPNs. This field is only applicable to RedCap UEs.
cellBarredRedCap2Rx (IE type: “barred” or “not barred”)
Indicated in a SIB1 message. In case of multiple PLMNs or NPNs indicated in SIB1, this field is common for all PLMNs and NPNs. This field is only applicable to RedCap UEs.
cellReservedForOperatorUse (IE type: “reserved” or “not reserved”)
Indicated in a SIB1 message. In case of multiple PLMNs or NPNs indicated in SIB1, this field is specified per PLMN or per SNPN.
cellReservedForOtherUse (IE type: “true”)
Indicated in a SIB1 message. In case of multiple PLMNs indicated in SIB1, this field is common for all PLMNs.
cellReservedForFuture Use (IE type: “true”)
Indicated in a SIB1 message. In case of multiple PLMNs or NPNs indicated in SIB1, this field is common for all PLMNs and NPNs.
NOTE 0: an integrated access backhaul mobile terminal (IAB-MT) ignores the cellBarred, cellReservedForOperator Use, cellReservedForFutureUse, and intraFreqReselection (i.e., the IAB-MT treats intraFreqReselection as if it was set to allowed). An IAB-MT also ignores cellReservedForOtherUse for cell barring determination (i.e., an NPN capable IAB-MT considers cellReservedForOtherUse for determination of an NPN-only cell).
halfDuplexRedCapAllowed (IE type: “true”)
Indicated in a SIB1 message. In case of multiple PLMNs or NPNs indicated in SIB1, this field is common for all PLMNs and NPNs. This field is only applicable to RedCap UEs.
iab-Support (IE type: “true”)
Indicated in a SIB1 message. In case of multiple PLMNs or NPNs indicated in SIB1, this field is specified per PLMN or per SNPN.

When the cell status is indicated as “not barred” and “not reserved” for operator use and not “true” for other use and not “true” for future use:
UEs shall treat this cell as a candidate during the cell selection and cell reselection procedures.

When a cell broadcasts any CAG-IDs or network identifiers (NIDs) and the cell status is indicated as “not barred” and “not reserved” for operator use and “true” for other use, and not “true” for future use:
All NPN-capable UEs shall treat this cell as a candidate during the cell selection and cell reselection procedures, and other UEs shall treat this cell as if the cell's status is “barred”.

When the cell status is indicated as “true” for other use, and either the cell does not broadcast any CAG-IDs or NIDs or does not broadcast any CAG-IDs and the UE is not operating in SNPN Access Mode:
The UE shall treat this cell as if the cell's status is “barred”.

When the cell status is indicated as “true” for future use,
The UE shall treat this cell as if the cell's status is “barred”.

When cellBarredNTN is not broadcast in this cell,
For NTN access, the UE shall treat this cell as if the cell's status is “barred”.

When halfDuplexRedCapAllowed is not broadcast in this cell,
A RedCap UE only capable of operating in half-duplex for FDD shall treat this cell as if the cell status is “barred”.

When the cell status is indicated as “not barred” and “reserved” for operator use for any PLMN/SNPN and not “true” for other use and not “true” for future use,
UEs assigned to Access Identity 11 or 15 operating in their HPLMN/EHPLMN shall treat this cell as a candidate during the cell selection and reselection procedures if the field cellReservedForOperatorUse for that PLMN set to “reserved”.
UEs assigned to Access Identity 11 or 15 shall treat this cell as a candidate during the cell selection and reselection procedures if the field cellReservedForOperatorUse for selected/registered SNPN is set to “reserved”.
UEs assigned to an Access Identity 0, 1, 2 and 12 to 14 shall behave as if the cell status is “barred” in case the cell is “reserved for operator use” for the registered PLMN/SNPN or the selected PLMN/SNPN.
UEs assigned to Access Identity 3 shall behave as if the cell status is “barred” in case the cell is “reserved for operator use” for the registered PLMN or the selected PLMN.

When the cell status “barred” is indicated or to be treated as if the cell status is “barred”,
The UE is not permitted to select/reselect this cell, not even for emergency calls.
The UE shall select another cell according to the following rule:
If the cell is to be treated as if the cell status is “barred” due to being unable to acquire the MIB:
   the UE may exclude the barred cell as a candidate for cell selection/reselection for up to 300 seconds.
   the UE may select another cell on the same frequency if the selection criteria are fulfilled.
Otherwise:
   If the UE is a RedCap UE, the UE shall acquire SIB1 and, in the remainder of this procedure, consider ‘intraFreqReselection in the MIB’ to be ‘intraFreqReselectionRedCap in SIB1’, if available.
      If the cell is to be treated as if the cell status is “barred” due to being unable to acquire the SIB1:
         the UE may exclude the barred cell as a candidate for cell selection/reselection for up to 300 seconds.
         the UE may select another cell on the same frequency if the selection criteria are fulfilled.
      If the cell status “barred” is indicated in the MIB but the UE is unable to acquire the SIB1; or
      If the cell is to be treated as if the cell status is “barred” due to not supporting RedCap UEs:
         the UE shall exclude the barred cell as a candidate for cell selection/reselection for 300 seconds.
         the UE may select another cell on the same frequency if re-selection criteria are fulfilled.
   If the UE is not a RedCap UE, or if the UE is a RedCap UE and intraFreqReselectionRedCap in SIB1 is available:
      If the field intraFreqReselection in the MIB message is set to “allowed”:
         the UE may select another cell on the same frequency if re-selection criteria are fulfilled;
         If the cell is to be treated as if the cell status is “barred” due to being unable to acquire the SIB1:
         the UE may exclude the barred cell as a candidate for cell selection/reselection for up to 300 seconds;
      Otherwise:
         the UE shall exclude the barred cell as a candidate for cell selection/reselection for 300 seconds.
   If the field intraFreqReselection in the MIB message is set to “not allowed”:
      If the cell is to be treated as if the cell status is “barred” due to being unable to acquire the SIB1:
         the UE may exclude the barred cell as a candidate for cell selection/reselection for up to 300 seconds;
         If the cell operates in licensed spectrum:
         the UE shall not re-select to another cell on the same frequency as the barred cell and exclude such cell(s) as candidate(s) for cell selection/reselection for 300 seconds;
         Otherwise:
         the UE may select to another cell on the same frequency if the reselection criteria are fulfilled.
      Otherwise:
         If the cell operates in licensed spectrum, or if this cell belongs to a PLMN which is indicated as being equivalent to the registered PLMN or the selected PLMN of the UE, or if this cell belongs to the registered SNPN or the selected SNPN of the UE:
         the UE shall not re-select to another cell on the same frequency as the barred cell and exclude such cell(s) as candidate(s) for cell selection/reselection for 300 seconds;
         Otherwise:
         the UE may select to another cell on the same frequency if the reselection criteria are fulfilled.
         the UE shall exclude the barred cell as a candidate for cell selection/reselection for 300 seconds.

In existing wireless communication systems, SIB1 is periodically transmitted in a cell by a gNB. The SIB1 transmission periodicity is 160 ms with repetition at every 20 ms within a 160 ms interval. Periodic transmissions lead to increased network energy consumption. On demand SIB1 transmission can reduce network energy consumption, wherein a cell can transmit SIB1 upon receiving a request from a UE instead of periodically broadcasting SIB1. In order to acquire SIB1 from a cell, assistance information can be provided by another cell. For example, a configuration to request SIB1 on a cell (e.g., Cell “B”) can be provided by another cell (e.g., Cell “A”). Several issues to be addressed to support on demand SIB1 transmission include, e.g.:
When the UE acquires a SIB1 request configuration for Cell B from Cell A;
before acquiring SIB1 of Cell B, whether the UE need checks if SIB1 is being broadcasted or provided on demand in Cell B, (note that it is possible that even though a SIB1 request configuration is provided, Cell B may be currently broadcasting SIB1);
signaling details of a SIB1 request configuration;
where to monitor for SIB1 after transmitting a request.

Various embodiments of the present disclosure provide mechanisms that address the issues noted above.

In some embodiments, a UE may first camp on Cell A and acquire a configuration to request SIB1 of Cell B, wherein the request for SIB1 is sent by the UE to Cell B. The UE may perform cell reselection to Cell B when reselection criteria as explained above are met. An issue with this procedure is that for cell reselection from Cell A to Cell B, the UE may use certain parameters (e.g., parameters to check whether access to the cell is restricted or not; parameters for a final check on cell selection criterion, etc.) which are included in SIB1 of Cell B for checking whether cell reselection criteria to reselect to Cell B is met. This delays the cell the reselection decision as the UE first sends an on demand SIB1 transmission request to Cell B to acquire SIB1 and then performs/validates the cell reselection criteria. If the cell reselection criteria is met, the UE then performs cell reselection and camps on Cell B. Various embodiments of the present disclosure provide mechanisms to reduce this delay.

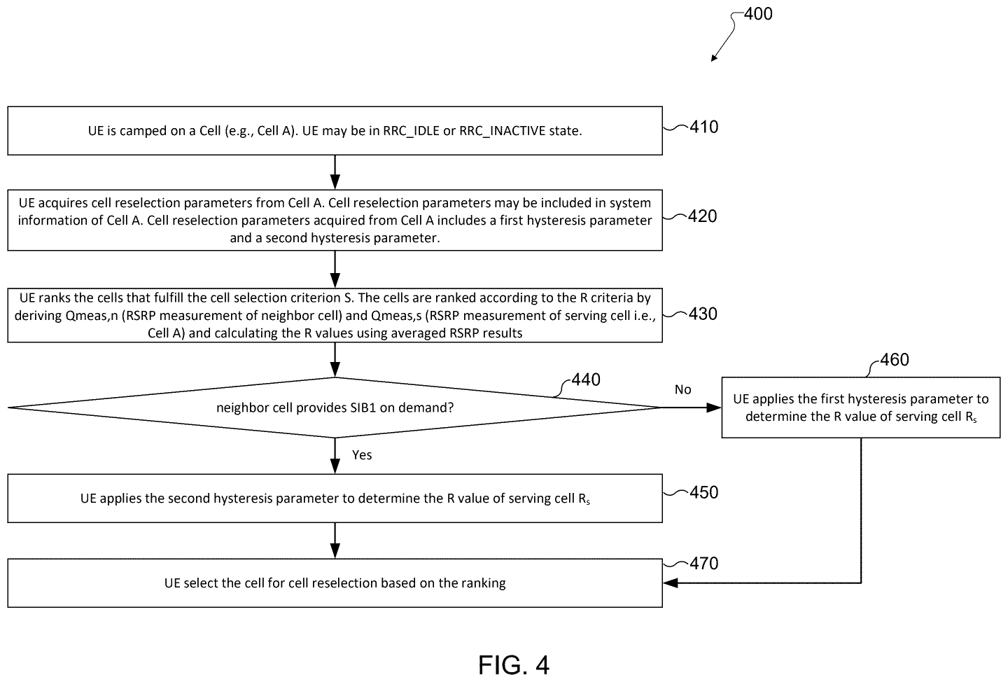

FIG. 4 illustrates an example procedure 400 for cell reselection according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for cell reselection could be used without departing from the scope of this disclosure.

In the example of FIG. 4, procedure 400 begins at operation 410. At operation 410, a UE (such as UE 116 of FIG. 1) is camped on a Cell (e.g., “Cell A”). The carrier or frequency of the Cell A is a frequency “F1”. The UE may be in an RRC_IDLE or RRC_INACTIVE state.

At operation 420, the UE acquires cell reselection parameters from Cell A. The cell reselection parameters acquired from Cell A includes a first hysteresis parameter (e.g., q-Hyst) and a second hysteresis parameter (e.g., q-Hyst-NES or q-Hyst-SIB1Request or q-Hyst-OnDemandSIB1).

At operation 430, while The UE is in the RRC_IDLE or RRC_INACTIVE state and camped to Cell A, the UE measures the neighboring cells and ranks the cells that fulfill the cell selection criterion S described herein. The cells are ranked according to the R criteria described herein by deriving Q_{meas,n (RSRP} measurement of neighbor cell) and Q_{meas,s (RSRP} measurement of serving cell i.e., Cell A) and calculating the R values using averaged RSRP results.

In some embodiments, at operation 440, if the neighbor cell provides SIB1 on demand (i.e., SIB1 is not broadcast periodically or provided upon request from a UE), at operation 450 the UE applies the second hysteresis parameter (i.e., Qhyst is set to the value of the second hysteresis parameter) to determine the R value of serving cell (Rs). Otherwise, at operation 460 (e.g., for a neighbor cell not providing SIB1 on demand), the UE applies the first hysteresis parameter (i.e., Qhyst is set to the value of the first hysteresis parameter) to determine the R value of serving cell (Rs).

In some embodiments, at operation 440, if the neighbor cell provides SIB1 on demand (i.e., SIB1 is not broadcast periodically or provided upon request from a UE) and the UE has a SIB1 request configuration, at operation 450 the UE applies the second hysteresis parameter (i.e., Qhyst is set to the value of the second hysteresis parameter) to determine the R value of serving cell (Rs). Otherwise, at operation 460 (e.g., for a neighbor cell not providing SIB1 on demand or the neighbor cell provides SIB1 on demand but the UE does not have a SIB1 request configuration), the UE applies the first hysteresis parameter (i.e., Qhyst is set to the value of first hysteresis parameter) to determine the R value of serving cell (Rs).

Alternately, in some embodiments, at operation 440, if there is a neighbor cell that fulfills the cell selection criterion S and provides SIB1 on demand (i.e., SIB1 is not broadcasted periodically or provided upon request from UE), at operation 450, the UE applies the second hysteresis parameter (i.e., Q_{hyst} is set to the value of second hysteresis parameter) to determine the R value of serving cell Rₛ. Otherwise, at operation 460, the UE applies the first hysteresis parameter (i.e., Q_{hyst} is set to the value of first hysteresis parameter) to determine the R value of serving cell (Rₛ).

Alternately, in some embodiments, at operation 440, if there is a neighbor cell that that fulfills the cell selection criterion S and provides SIB1 on demand (i.e., SIB1 is not broadcasted periodically or provided upon request from UE) and the UE has a SIB1 request configuration, at operation 450, the UE applies the second hysteresis parameter (i.e., Q_{hyst} is set to the value of second hysteresis parameter) to determine the R value of serving cell Rₛ. Otherwise, at operation 460, the UE applies the first hysteresis parameter (i.e., Q_{hyst} is set to the value of first hysteresis parameter) to determine the R value of serving cell (Rₛ).

The R values are derived as follows:

$${R}_{s} = {Q}_{meas , s} + {Q}_{h y s t} - {Qoffset}_{t e m p}$$

$${R}_{n} = {Q}_{meas , n} - Qoffset - {Qoffset}_{t e m p}$$

where:

TABLE 3

| | |
|---|---|
| Qₘₑₐₛ | RSRP measurement quantity used in cell reselections. |
| Qoffset | For intra-frequency: Equals to Qoffset_{s, n}, if Qoffset_{s, n} is valid, |
| | otherwise this equals to zero. Qoffset_{s, n} may be received in system |
| | information and can be cell specific. |
| | For inter-frequency: Equals to Qoffset_{s, n} plus Qoffset_{frequency}, if |
| | Qoffset_{s, n} is valid, otherwise this equals to Qoffset_{frequency}. Qoffset_{s, n} |
| | and Qoffset_{frequency} may be received in system information and are |
| | frequency specific for inter frequency cell reselection. |
| Qoffsetₜₑₘₚ | Offset temporarily applied to a cell for connEstFailOffsetValidity |
| | duration if the connection establishment has failed on this cell |
| | connEstFailCount times |

With this mechanism the network may set a lower value for the second hysteresis parameter to initiate the cell reselection to a neighbor cell providing on demand SIB1 transmission earlier.

At operation 470, based on ranking the UE selects the cell for cell reselection as earlier explained herein.
If rangeToBestCell is not configured, the UE shall perform cell reselection to the highest ranked cell provided that access to that cell is not restricted as per cell access criteria.
If rangeToBestCell is configured, then the UE shall perform cell reselection to the cell with the highest number of beams above the threshold (i.e., absThreshSS-BlocksConsolidation) among the cells whose R value is within rangeToBestCell of the R value of the highest ranked cell provided that access to that cell is not restricted as per cell access criteria. If there are multiple such cells, the UE shall perform cell reselection to the highest ranked cell among them, provided that access to that cell is not restricted as per cell access criteria.
In all cases, the UE shall reselect the new cell, only if the following conditions are met:
   the new cell is better than the serving cell according to the cell reselection criteria specified above during a time interval Treselection_{RAT};
   more than 1 second has elapsed since the UE camped on the current serving cell.

Although FIG. 4 illustrates one example procedure 400 for cell reselection, various changes may be made to FIG. 4. For example, while shown as a series of operations, various operations in FIG. 4 could overlap, occur in parallel, occur in a different order, occur any number of times, be omitted, or replaced by other operations.

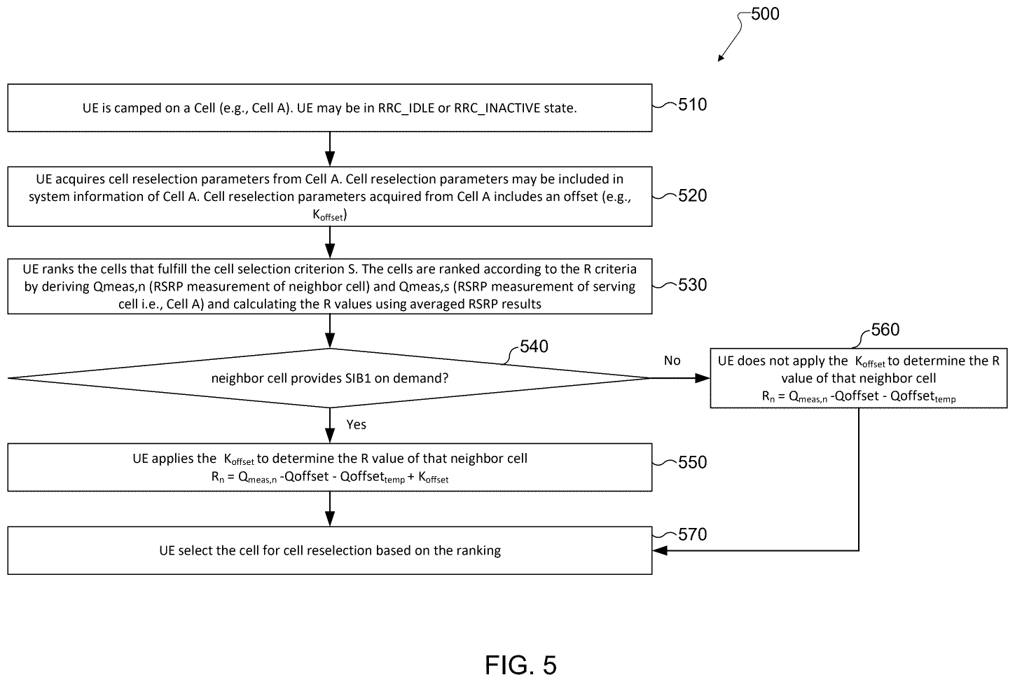

FIG. 5 illustrates another example procedure 500 for cell reselection according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for cell reselection could be used without departing from the scope of this disclosure.

In the example of FIG. 5, procedure 500 begins at operation 510. At operation 510, a UE (such as UE 116 of FIG. 1) is camped on a Cell (e.g., “Cell A”). The carrier or frequency of the Cell A is a frequency “F1”. The UE may be in an RRC_IDLE or RRC_INACTIVE state.

At operation 520, the UE acquires cell reselection parameters from Cell A. In some embodiments, the cell reselection parameters acquired from Cell A include an offset (e.g., “K_{offset}”). K_{offset} can be in dB or dBm.

At operation 530, while the UE is in the RRC_IDLE or RRC_INACTIVE state and camped to Cell A, the UE measures the neighboring cells and ranks the cells that fulfill the cell selection criterion S. The cells are ranked according to the R criteria by deriving Q_{meas,n (RSRP} measurement of neighbor cell) and Q_{meas,s (RSRP} measurement of serving cell i.e., Cell A) and calculating the R values using averaged RSRP results.

In some embodiments, at operation 540, if the neighbor cell provides SIB1 on demand (i.e., SIB1 is not broadcast periodically or provided upon request from a UE), at operation 550 the UE applies K_{offset} to determine the R value of the neighbor cell. Otherwise, at operation 560 (e.g., for a neighbor cell not providing SIB1 on demand), the UE applies K_{offset}=0 or K_{offset} is not applied to determine the R value of the neighbor cell.

In some embodiments, at operation 540, if the neighbor cell provides SIB1 on demand (i.e., SIB1 is not broadcast periodically or provided upon request from a UE) and the UE has a SIB1 request configuration of the neighbor cell, at operation 550 the UE applies K_{offset} to determine the R value of the neighbor cell. Otherwise, at operation 560 (e.g., for a neighbor cell not providing SIB1 on demand or the UE does not have SIB1 request configuration for the neighbor cell), the UE applies K_{offset}=0 or K_{offset} is not applied to determine the R value of the neighbor cell.

In some embodiments, at operation 540, if there is a neighbor cell that fulfills the cell selection criterion S and provides SIB1 on demand (i.e., SIB1 is not broadcast periodically or provided upon request from a UE), at operation 550 the UE applies K_{offset} to determine the R value of the neighbor cell. Otherwise, at operation 560 (e.g., for a neighbor cell not providing SIB1 on demand), the UE applies K_{offset}=0 or K_{offset} is not applied to determine the R value of the neighbor cell.

In some embodiments, at operation 540, if there is a neighbor cell that fulfills the cell selection criterion S and provides SIB1 on demand (i.e., SIB1 is not broadcast periodically or provided upon request from a UE) and the UE has a SIB1 request configuration of the neighbor cell, at operation 550 the UE applies K_{offset} to determine the R value of the neighbor cell. Otherwise, at operation 560 (e.g., for a neighbor cell not providing SIB1 on demand or the UE does not have SIB1 request configuration for the neighbor cell), the UE applies K_{offset}=0 or K_{offset} is not applied to determine the R value of the neighbor cell.

The R values are derived as follows:

$${R}_{s} = {Q}_{meas , s} + {Q}_{h y s t} - {Qoffset}_{t e m p}$$

$${R}_{n} = {Q}_{meas , n} - Qoffset - {Qoffset}_{t e m p} + {K}_{o f f s e t}$$

$$OR$$

$${R}_{n} = {Q}_{meas , n} + {K}_{offset}$$

With this mechanism the network may set the K_{offset} to initiate the cell reselection to a neighbor cell providing on demand SIB1 transmission earlier.

At operation 570, based on ranking the UE selects the cell for cell reselection as earlier explained herein.
If rangeToBestCell is not configured, the UE shall perform cell reselection to the highest ranked cell provided that access to that cell is not restricted as per cell access criteria.
If rangeToBestCell is configured, then the UE shall perform cell reselection to the cell with the highest number of beams above the threshold (i.e., absThreshSS-BlocksConsolidation) among the cells whose R value is within rangeToBestCell of the R value of the highest ranked cell provided that access to that cell is not restricted as per cell access criteria. If there are multiple such cells, the UE shall perform cell reselection to the highest ranked cell among them, provided that access to that cell is not restricted as per cell access criteria.
In all cases, the UE shall reselect the new cell, only if the following conditions are met:
   the new cell is better than the serving cell according to the cell reselection criteria specified above during a time interval Treselection_{RAT};
   more than 1 second has elapsed since the UE camped on the current serving cell.

Although FIG. 5 illustrates one example procedure for procedure 500 for cell reselection, various changes may be made to FIG. 5. For example, while shown as a series of operations, various operations in FIG. 5 could overlap, occur in parallel, occur in a different order, occur any number of times, be omitted, or replaced by other operations.

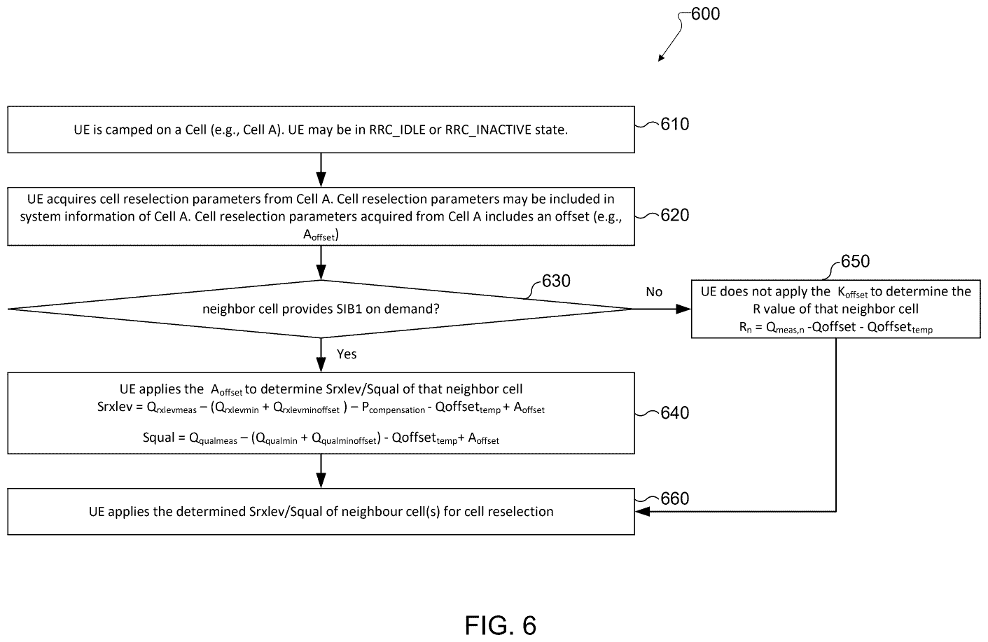

FIG. 6 illustrates another example procedure 600 for cell reselection according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for cell reselection could be used without departing from the scope of this disclosure.

In the example of FIG. 6, procedure 600 begins at operation 610. At operation 610, a UE (such as UE 116 of FIG. 1) is camped on a Cell (e.g., “Cell A”). The carrier or frequency of the Cell A is a frequency “F1”. The UE may be in an RRC_IDLE or RRC_INACTIVE state.

At operation 620, while UE is in the RRC_IDLE or RRC_INACTIVE state and camped to Cell A, the UE acquires cell reselection parameters from Cell A. The cell reselection parameters may be included in system information of Cell A. The cell reselection parameters acquired from Cell A include an offset (e.g., “A_{offset}”). A_{offset} can be in dB or dBm.

In some embodiments, at operation 630, if the neighbor cell provides SIB1 on demand (i.e., SIB1 is not broadcast periodically or provided upon request from a UE), at operation 640 the UE applies A_{offset} to determine the Srxlev/Squal of the neighbor cell. Otherwise, at operation 650 (e.g., for a neighbor cell not providing SIB1 on demand), the UE applies A_{offset}=0 or A_{offset} is not applied to determine the Srxlev/Squal of the neighbor cell.

In some embodiments, at operation 630, if the neighbor cell provides SIB1 on demand (i.e., SIB1 is not broadcast periodically or provided upon request from a UE) and the UE has a SIB1 request configuration of the neighbor cell, at operation 640 the UE applies A_{offset} to determine the Srxlev/Squal of the neighbor cell. Otherwise, at operation 650 (e.g., for a neighbor cell not providing SIB1 on demand or the UE does not have SIB1 request configuration for the neighbor cell), the UE applies A_{offset}=0 or A_{offset} is not applied to determine the Srxlev/Squal of the neighbor cell.

$$Srxlev = {Q}_{rxlevmeas} - ( {Q}_{rxlevmin} + {Q}_{rxlevminoffset} ) - {P}_{compensation} - {Qoffset}_{t e m p} + {A}_{offset}$$

$$Squal = {Q}_{qualmeas} - ( {Q}_{qualmin} + {Q}_{qualminoffset} ) - {Qoffset}_{t e m p} + {A}_{offset}$$

For intra-frequency and equal priority inter-frequency cell reselection the UE ranks the cells that fulfill the cell selection criterion S (i.e., Srxlev>0 AND Squal>0). The cells are ranked according to the R criteria by deriving Q_{meas,n} (RSRP measurement of neighbor cell) and Q_{meas,s} (RSRP measurement of serving cell i.e., Cell A) and calculating the R values using averaged RSRP results. At operation 660, Based on the ranking the UE selects the cell for cell reselection.
If rangeToBestCell is not configured, the UE shall perform cell reselection to the highest ranked cell provided that access to that cell is not restricted as per cell access criteria.
If rangeToBestCell is configured, then the UE shall perform cell reselection to the cell with the highest number of beams above the threshold (i.e., absThreshSS-BlocksConsolidation) among the cells whose R value is within rangeToBestCell of the R value of the highest ranked cell provided that access to that cell is not restricted as per cell access criteria. If there are multiple such cells, the UE shall perform cell reselection to the highest ranked cell among them, provided that access to that cell is not restricted as per cell access criteria.
In all cases, the UE shall reselect the new cell, only if the following conditions are met:
   the new cell is better than the serving cell according to the cell reselection criteria specified above during a time interval Treselection_{RAT};
   more than 1 second has elapsed since the UE camped on the current serving cell.

For NR inter-frequency and inter-RAT cell reselection criteria, the UE can reselect to another cell on a frequency different from the frequency of the currently camped cell but having a different frequency priority than the frequency priority of currently camped cell as follows:

If threshServingLowQ is broadcast in system information and more than 1 second has elapsed since the UE camped on the current serving cell, cell reselection to a cell on a higher priority NR frequency or inter-RAT frequency than the serving frequency shall be performed if:
A cell of a higher priority NR or EUTRAN RAT/frequency fulfills Squal>Thresh_{X, HighQ} during a time interval Treselection_{RAT}.

Otherwise, cell reselection to a cell on a higher priority NR frequency or inter-RAT frequency than the serving frequency shall be performed if:
A cell of a higher priority RAT/frequency fulfills Srxlev>Thresh_{X, HighP} during a time interval Treselection_{RAT}; and
More than 1 second has elapsed since the UE camped on the current serving cell.

If threshServingLowQ is broadcast in system information and more than 1 second has elapsed since the UE camped on the current serving cell, cell reselection to a cell on a lower priority NR frequency or inter-RAT frequency than the serving frequency shall be performed if:
The serving cell fulfills Squal<Thresh_{Serving, LowQ} and a cell of a lower priority NR or E-UTRAN RAT/frequency fulfills Squal>Thresh_{X, LowQ} during a time interval Treselection_{RAT}.

Otherwise, cell reselection to a cell on a lower priority NR frequency or inter-RAT frequency than the serving frequency shall be performed if:
The serving cell fulfills Srxlev<Thresh_{Serving, LowP} and a cell of a lower priority RAT/frequency fulfills Srxlev>Thresh_{X, LowP} during a time interval Treselection_{RAT}; and
More than 1 second has elapsed since the UE camped on the current serving cell.

Although FIG. 6 illustrates one example procedure 600 for cell reselection, various changes may be made to FIG. 6. For example, while shown as a series of operations, various operations in FIG. 6 could overlap, occur in parallel, occur in a different order, occur any number of times, be omitted, or replaced by other operations.

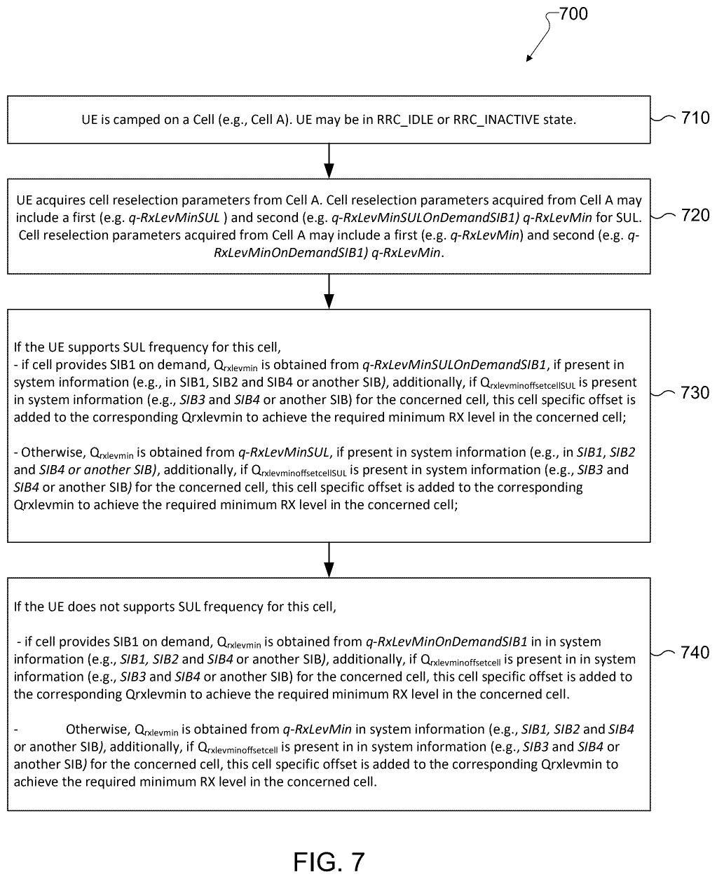

FIG. 7 illustrates another example procedure 700 for cell reselection according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for cell reselection could be used without departing from the scope of this disclosure.

In the example of FIG. 7, procedure 700 begins at operation 710. At operation 710, a UE (such as UE 116 of FIG. 1) is camped on a Cell (e.g., “Cell A”). The UE may be in an RRC_IDLE or RRC_INACTIVE state.

At operation 720, while UE is in the RRC_IDLE or RRC_INACTIVE state and camped to Cell A, the UE acquires cell reselection parameters from Cell A. The cell reselection parameters acquired from Cell A may include a first (e.g., q-RxLevMinSUL) and second (e.g., q-RxLevMinSULOnDemandSIB1) q-RxLevMin for SUL. The cell reselection parameters acquired from Cell A may include a first (e.g., q-RxLevMin) and second (e.g., q-RxLevMinOnDemandSIB1) q-RxLevMin.

In some embodiments, at operations 730 and 740, the UE determines the Qᵣₓₗₑᵥₘᵢₙ for determining Srxlev (Qᵣₓₗₑᵥₘₑₐₛ−(Qᵣₓₗₑᵥₘᵢₙ+Q_{rxlevminoffset})−P_{compensation}−Qoffsetₜₑₘₚ) and Squal (Q_{qualmeas}−(Q_{qualmin}+Q_{qualminoffset})−Qoffsetₜₑₘₚ) for a neighbor cell as follows:

If the UE supports the SUL frequency for this cell, at operation 730,
If the cell provides SIB1 on demand (or if the cell provides SIB1 on demand and the UE has a SIB1 request configuration for the cell), Qᵣₓₗₑᵥₘᵢₙ is obtained from q-RxLevMinSULOnDemandSIB1, if present in system information (e.g., in SIB1, SIB2 and SIB4 or another SIB). Additionally, if Q_{rxlevminoffsetcellSUL} is present in system information (e.g., SIB3 and SIB4 or another SIB) for the concerned cell, this cell specific offset is added to the corresponding Qrxlevmin to achieve the required minimum RX level in the concerned cell;
Otherwise, Qᵣₓₗₑᵥₘᵢₙ is obtained from q-RxLevMinSUL, if present in system information (e.g., in SIB1, SIB2 and SIB4 or another SIB). Additionally, if Q_{rxlevminoffsetcellSUL} is present in system information (e.g., SIB3 and SIB4 or another SIB) for the concerned cell, this cell specific offset is added to the corresponding Qrxlevmin to achieve the required minimum RX level in the concerned cell;

Otherwise, if the UE does not support the SUL frequency for this cell, at operation 740,
If the cell provides SIB1 on demand (or if the cell provides SIB1 on demand and the UE has a SIB1 request configuration for the cell), Qᵣₓₗₑᵥₘᵢₙ is obtained from q-RxLevMinOnDemandSIB1 in in system information (e.g., SIB1, SIB2 and SIB4 or another SIB). Additionally, if Q_{rxlevminoffsetcell} is present in in system information (e.g., SIB3 and SIB4 or another SIB) for the concerned cell, this cell specific offset is added to the corresponding Qrxlevmin to achieve the required minimum RX level in the concerned cell.
Otherwise, Qᵣₓₗₑᵥₘᵢₙ is obtained from q-RxLevMin in system information (e.g., SIB1, SIB2 and SIB4 or another SIB). Additionally, if Q_{rxlevminoffsetcell} is present in in system information (e.g., SIB3 and SIB4 or another SIB) for the concerned cell, this cell specific offset is added to the corresponding Qrxlevmin to achieve the required minimum RX level in the concerned cell.

Alternatively, in some embodiments, at operations 730 and 740 the UE determines the Qᵣₓₗₑᵥₘᵢₙ for determining Srxlev (Qᵣₓₗₑᵥₘₑₐₛ−(Qᵣₓₗₑᵥₘᵢₙ+Q_{rxlevminoffset})−P_{compensation}−Qoffsetₜₑₘₚ) and Squal (Q_{qualmeas}−(Q_{qualmin}+Q_{qualminoffset})−Qoffsetₜₑₘₚ) for a neighbor cell as follows:

If the cell the provides SIB1 on demand (or if the cell provides SIB1 on demand and the UE has a SIB1 request configuration for the cell),
Qᵣₓₗₑᵥₘᵢₙ is obtained from q-RxLevMinOnDemandSIB1, if present in system information (e.g., in SIB1, SIB2 and SIB4 or another SIB). Additionally, if Q_{rxlevminoffsetcellOndemandSIB} is present in system information (e.g., SIB3 and SIB4 or another SIB) for the concerned cell, this cell specific offset is added to the corresponding Qrxlevmin to achieve the required minimum RX level in the concerned cell;

Otherwise, if the cell does not provide SIB1 on demand:
If the UE supports the SUL frequency for this cell, Qᵣₓₗₑᵥₘᵢₙ is obtained from q-RxLevMinSUL, if present, in SIB1, SIB2 and SIB4. Additionally, if Q_{rxlevminoffsetcellSUL} is present in SIB3 and SIB4 for the concerned cell, this cell specific offset is added to the corresponding Qrxlevmin to achieve the required minimum RX level in the concerned cell;
Otherwise Qᵣₓₗₑᵥₘᵢₙ is obtained from q-RxLevMin in SIB1, SIB2 and SIB4. Additionally, if Q_{rxlevminoffsetcell} is present in SIB3 and SIB4 for the concerned cell, this cell specific offset is added to the corresponding Qrxlevmin to achieve the required minimum RX level in the concerned cell.

The UE applies the determined Srxlev/Squal of neighbor cell(s) for cell reselection.

In some embodiments, for intra-frequency and equal priority inter-frequency cell reselection the UE reselects the new cell only if the following conditions are met:
If the cell provides SIB1 on demand (or if the cell provides SIB1 on demand and the UE has a SIB1 request configuration for the cell)
   the new cell is better than the serving cell according to the cell reselection criteria specified above during a first time interval (i.e., TreselectionRATOnDemandSIB1); the first time interval is acquired from system information of serving cell (i.e., Cell A).
Otherwise:
   the new cell is better than the serving cell according to the cell reselection criteria specified above during a second time interval (i.e., TreselectionRAT); second time interval is acquired from system information of serving cell i.e., Cell A.
more than 1 second has elapsed since the UE camped on the current serving cell.

In some embodiments, for NR Inter-frequency and inter-RAT cell reselection criteria, the UE can reselect to another cell on a frequency different from the frequency of the currently camped cell but having a different frequency priority than the frequency priority of the currently camped cell as follows:
If threshServingLowQ is broadcast in system information and more than 1 second has elapsed since the UE camped on the current serving cell, cell reselection to a cell on a higher priority NR frequency or inter-RAT frequency than the serving frequency shall be performed if:
   a cell of a higher priority NR or EUTRAN RAT/frequency fulfills Squal>Thresh_{X, HighQ} during a time interval Treselection_{RAT}.
   A first and second Treselection_{RAT} can be received by the UE from system information of Cell A. The first Treselection_{RAT} is applied for reselecting to a cell providing on demand SIB1 transmission. Otherwise, the second Treselection_{RAT} is applied.
   A first and second Thresh_{X, HighQ} can be received by the UE from system information of Cell A. The first Thresh_{X, HighQ} is applied for reselecting to a cell providing on demand SIB1 transmission. Otherwise, the second Thresh_{X, HighQ} is applied.
Otherwise, cell reselection to a cell on a higher priority NR frequency or inter-RAT frequency than the serving frequency shall be performed if:
   a cell of a higher priority RAT/frequency fulfills Srxlev>Thresh_{X, HighP} during a time interval Treselection_{RAT}; and
   more than 1 second has elapsed since the UE camped on the current serving cell.
   A first and second Thresh_{X, HighP} can be received by the UE from system information of Cell A. The first Thresh_{X, HighP} is applied for reselecting to a cell providing on demand SIB1 transmission. Otherwise, the second Thresh_{X, HighP} is applied.
   A first and second Treselection_{RAT} can be received by the UE from system information of Cell A. The first Treselection_{RAT} is applied for reselecting to a cell providing on demand SIB1 transmission. Otherwise, the second Treselection_{RAT} is applied.
If threshServingLowQ is broadcast in system information and more than 1 second has elapsed since the UE camped on the current serving cell, cell reselection to a cell on a lower priority NR frequency or inter-RAT frequency than the serving frequency shall be performed if:
   the serving cell fulfills Squal<Thresh_{Serving, LowQ} and a cell of a lower priority NR or E-UTRAN RAT/frequency fulfills Squal>Thresh_{X, LowQ} during a time interval Treselection_{RAT}.
   A first and second Thresh_{X, LowQ} can be received by the UE from system information of Cell A. the first Thresh_{X, LowQ} is applied for reselecting to a cell providing on demand SIB1 transmission. Otherwise, the second Thresh_{X, LowQ} is applied.
   A first and second TreselectionRAT can be received by the UE from system information of Cell A. the first TreselectionRAT is applied for reselecting to a cell providing on demand SIB1 transmission. Otherwise, the second TreselectionRAT is applied.
Otherwise, cell reselection to a cell on a lower priority NR frequency or inter-RAT frequency than the serving frequency shall be performed if:
   The serving cell fulfills Srxlev<Thresh_{Serving, LowP} and a cell of a lower priority RAT/frequency fulfills Srxlev>Thresh_{X, LowP} during a time interval Treselection_{RAT}; and
   More than 1 second has elapsed since the UE camped on the current serving cell.
   A first and second Thresh_{X, LowQ} can be received by the UE from system information of Cell A. The First Thresh_{X, LowP} is applied for reselecting to a cell providing on demand SIB1 transmission. Otherwise, the second Thresh_{X, LowP} is applied.
   A first and second TreselectionRAT can be received by the UE from system information of Cell A. The first TreselectionRAT is applied for reselecting to cell providing on demand SIB1 transmission. Otherwise, the second TreselectionRAT is applied.

In some embodiments, amongst the ranked cells based on R criterion (note that cells which meet S criterion are ranked based on R criterion), the UE may prioritize selecting the highest ranked cell amongst the cells periodically broadcasting SIB1 (if allowed by the network, the network may allow broadcasting SIB1 by indicating the same by signaling a parameter in system information of Cell A). For example, assume the rank of Cell B>the rank of Cell C>the rank of Cell D>the rank of Cell E based on R criterion. Cell C and Cell D periodically broadcast SIB1. Cell B and Cell E provide SIB1 on demand. The UE selects Cell C for cell reselection instead of Cell B.

Alternately, in some embodiments, amongst the first N (N can be pre-defined or signaled) ranked cells based on R criterion (note that cells which meet S criterion are ranked based on R criterion), the UE may prioritize selecting the highest ranked cell amongst the cells periodically broadcasting SIB1 (if allowed by the network, the network may allow broadcasting SIB1 by indicating the same by signaling a parameter in system information of Cell A).

In some embodiments, amongst the ranked cells based on R criterion, the UE may prioritize selecting the highest ranked cell amongst the cells providing on demand SIB1 transmission (if allowed by network, the network may allow on demand SIB1 transmission by indicating the same by signaling a parameter in system information of Cell A). For example, assume the rank of Cell B>the rank of Cell C>the rank of Cell D>the rank of Cell E based on R criterion. Cell C and Cell D provide SIB1 on demand. The UE selects Cell C for cell reselection instead of Cell B.

Alternately, in some embodiments, amongst the first N (N can be pre-defined or signaled) ranked cells based on R criterion (note that cells which meet S criterion are ranked based on R criterion), The UE may prioritize selecting the highest ranked cell amongst the cells providing on demand SIB1 transmission (if allowed by the network, the network may allow by indicating the same by signaling a parameter in system information of Cell A).

In some embodiments, several cells may be deployed on the same carrier frequency. Some cells may support/provide on demand SIB1 transmission and/or other network energy saving (NES) features and some cells may not support these NES features. The carrier frequency can be configured/signaled with two priorities. The first priority is applied for reselecting to cells of the carrier frequency support/provide on demand SIB1 transmission and/or other NES features. The second priority is applied for reselecting to other cells of the carrier.
Assume a first and second priority configured/signaled for a carrier frequency are P1 and P2. If a cell on a carrier frequence F1 supports/provides on demand SIB1 transmission and/or other NES features, the priority of the carrier frequency of this cell is first priority (i.e., P1). Otherwise, the priority of the carrier frequency of this cell is second priority (i.e., P2). The UE shall use the determined priority for cell reselection.
   The UE is camped to Cell A. the UE selects a target cell for reselection based on measurements and cell reselection parameters received from Cell A.
The UE can reselect to the target cell only if access to that cell is not restricted as per cell access criteria. For checking cell access criteria, the UE acquires SIB1 of the target cell. If the SIB1 is provided on demand, the UE requests SIB1 which will delay cell reselection.
The UE also performs a final check on cell selection criterion (Squal, Srxlev) using parameters provided by the target cell for cell reselection. For checking this, the UE acquires SIB1 of the target cell. If SIB1 is provided on demand, the UE requests for SIB1 which will delay cell reselection.
In some embodiments, if SIB1 is provided on demand for a target cell selected for cell reselection, the UE does not need to perform a final check of cell selection criterion (Squal, Srxlev) using parameters provided by the target cell for cell reselection. If SIB1 is not provided on demand for the target cell (i.e., if SIB1 is periodically broadcasted or being broadcast), the UE performs a final check of cell selection criterion (Squal, Srxlev) using parameters provided by the target cell for cell reselection.
In some embodiments, for checking cell access criteria (i.e., for checking if access to that cell is not restricted as per cell access criteria), cell access related configuration and barring configuration (as described earlier) of the target cell can be signaled to the UE by the serving cell (i.e., Cell A). The serving cell (i.e., Cell A) can obtain these parameters from a target cell over an Xn interface and provide the same to the UE using system information of Cell A. If provided, the UE can use these parameters to determine if access to that cell is not restricted as per cell access criteria or the cell is not barred based on the barring configuration. The UE does not need to acquire SIB1 for this. After checking that cell access is not restricted and/or the cell is not barred based on information received in Cell A, the UE proceeds with cell reselection and acquires the MIB and sends a SIB1 request to the target cell. The cell access related configuration of target cell may include one or more of the following parameters.

```
        CellAccessRelatedInfo ::= SEQUENCE {
  plmn-IdentityInfoList PLMN-IdentityInfoList,
  cellReservedForOtherUse ENUMERATED {true} OPTIONAL, -- Need R
  ...,
  [[
  cellReservedForFutureUse-r16  ENUMERATED {true} OPTIONAL, -- Need R
  npn-IdentityInfoList-r16  NPN-IdentityInfoList-r16  OPTIONAL -- Need R
  ]],
  [[
  snpn-AccessInfoList-r17  SEQUENCE (SIZE (1..maxNPN-r16)) OF SNPN-
AccessInfo-r17 OPTIONAL -- Need R
  ]]
}
SNPN-AccessInfo-r17 ::= SEQUENCE {
  extCH-Supported-r17 ENUMERATED {true} OPTIONAL, -- Need R
  extCH-WithoutConfigAllowed-r17  ENUMERATED {true} OPTIONAL, -- Need
R
  onboardingEnabled-r17 ENUMERATED {true} OPTIONAL, -- Need R
  imsEmergencySupportForSNPN-r17  ENUMERATED {true} OPTIONAL --
Need R
}
```

TABLE 4
CellAccessRelatedInfo field descriptions
cellReservedForFutureUse
Indicates whether the cell is reserved, as defined in 38.304 [20] for future use. The field is
applicable to all PLMNs and NPNs. This field is ignored by IAB-MT and NCR-MT.
cellReservedForOtherUse
Indicates whether the cell is reserved, as defined in 38.304 [20]. The field is applicable to all
PLMNs. This field is ignored by IAB-MT and NCR-MT for cell barring determination, but
still considered by NPN capable IAB-MT and NPN capable NCR-MT for determination of an
NPN-only cell.
npn-IdentityInfoList
The npn-IdentityInfoList is used to configure a set of NPN-IdentityInfo elements. Each of
those elements contains a list of one or more NPN Identities and additional information
associated with those NPNs. The total number of PLMNs (identified by a PLMN identity in
plmn -IdentityList), PNI-NPNs (identified by a PLMN identity and a CAG-ID), and SNPNs
(identified by a PLMN identity and a NID) together in the PLMN-IdentityInfoList and NPN-
IdentityInfoList does not exceed 12, except for the NPN-only cells. A PNI-NPN and SNPN
can be included only once, and in only one entry of the NPN-IdentityInfoList. In case of NPN-
only cells the PLMN-IdentityList contains a single element that does not count to the limit of
12 and the cellIdentity of the first entry of the PLMN-IdentityInfoList is set to the same value
as the cellIdentity-r16 of the first entry of the NPN-IdentityInfoList. The NPN index is defined
as B + c1 + c2 + . . . + c(n − 1) + d1 + d2 + . . . +d(m − 1) + e(i) for the NPN identity included in the n-th
entry of NPN-IdentityInfoList and in the m-th entry of npn-Identitylist within that NPN-
IdentityInfoList entry, and the i-th entry of its corresponding NPN-Identity, where
B is the index used for the last PLMN in the PLMN-IdentityInfoList; in NPN-only cells B is
considered 0;
c(j) is the number of NPN index values used in the j-th NPN-IdentityInfoList entry;
d(k) is the number of NPN index values used in the k-th npn-IdentityList entry within the n-
th NPN-IdentityInfoList entry;
e(i) is
i if the n-th entry of NPN-IdentityInfoList entry is for SNPN(s);
l if the n-th entry of NPN-IdentityInfoList entry is for PNI-NPN(s).
plmn-IdentityInfoList
The plmn-IdentityInfoList is used to configure a set of PLMN-IdentityInfo elements. Each of
those elements contains a list of one or more PLMN Identities and additional information
associated with those PLMNs. A PLMN-identity can be included only once, and in only one
entry of the PLMN-IdentityInfoList. The PLMN index is defined as b1 + b2 + . . . + b(n − 1) + i for
the PLMN included at the n-th entry of PLMN-IdentityInfoList and the i-th entry of its
corresponding PLMN-IdentityInfo, where b(j) is the number of PLMN-Identity entries in each
PLMN-IdentityInfo, respectively.
snpn-AccessInfoList
This list provides access related information for each SNPN in npn-IdentityInfoList. The n-th
entry of the list contains the access related information of the n-th SNPN in npn-
IdentityInfoList.

TABLE 5
SNPN-AccessInfo field descriptions
extCH-Supported
Indicates whether the SNPN supports access using credentials from a Credentials Holder.
extCH-WithoutConfigAllowed
Indicates whether the SNPN allows registration attempts with credentials from a Credentials
Holder from UEs that are not explicitly configured to select the SNPN.
imsEmergencySupportForSNPN
Indicates whether the SNPN supports IMS emergency bearer services for UEs in limited
service mode in the cell. If absent, IMS emergency call is not supported by the SNPN in the
cell for UEs in limited service mode.
onboarding Enabled
Indicates whether the onboarding SNPN allows registration for onboarding in the cell.

Although FIG. 7 illustrates one example procedure 700 for cell reselection, various changes may be made to FIG. 7. For example, while shown as a series of operations, various operations in FIG. 7 could overlap, occur in parallel, occur in a different order, occur any number of times, be omitted, or replaced by other operations.

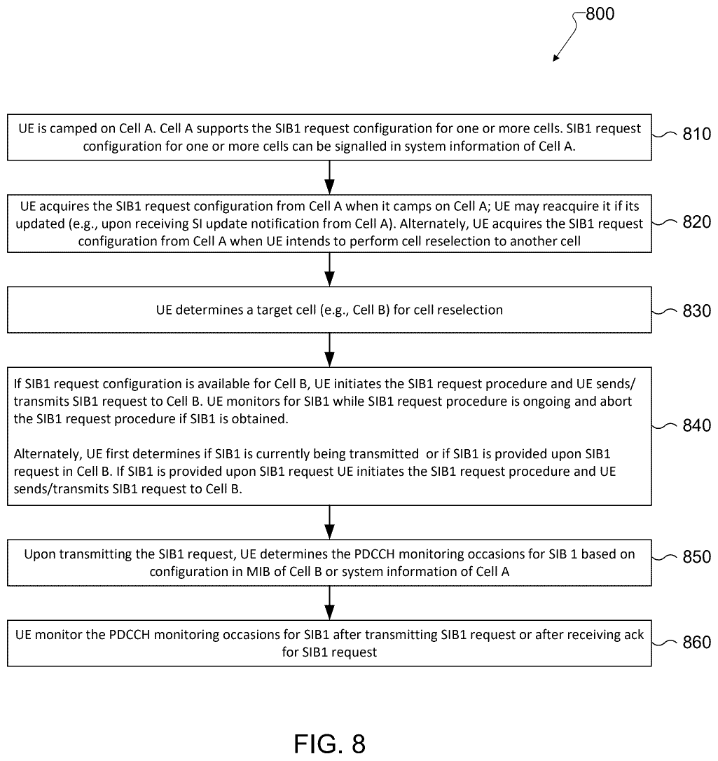

FIG. 8 illustrates an example procedure 800 for SIB1 acquisition according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for SIB1 acquisition could be used without departing from the scope of this disclosure.

In the example of FIG. 8, procedure 800 begins at operation 810. At operation 810, a UE (such as UE 116 of FIG. 1) is camped on a Cell (e.g., “Cell A”). Cell A supports (e.g., broadcasts periodically/provide on demand) the SIB1 request configuration for one or more cells (the cells can be neighboring cells of Cell A). The SIB1 request configuration for one or more cells can be signaled in system information (e.g., a SIB) of Cell A.

In some embodiments, at operation 820, the UE acquires the SIB1 request configuration from Cell A when the UE camps on Cell A. The UE may reacquire the SIB1 request configuration if the SIB1 request configuration is updated (e.g., upon receiving an SI update notification from Cell A).

Alternatively, in some embodiments, at operation 820 the UE acquires the SIB1 request configuration from Cell A when the UE intends to perform cell reselection to another cell (e.g., Cell B). Cell B is the target cell for reselection based on cell reselection criteria.

In some embodiments, Cell A may signal a first list of one or more SIB1 request configurations and a second list of one or more carriers (frequencies) supporting on demand SIB1 transmission. The carrier can be indicated by an absolute radio-frequency channel number (ARFCN). Each entry in the second list can include an index of an entry in the first list to indicate SIB1 request configurations for each carrier. The SIB1 request configuration for a cell is the SIB1 request configuration corresponding to the carrier of that cell.

In some embodiments, Cell A may signal a first list of one or more SIB1 request configurations and a second list of one or more carriers (frequencies) supporting on demand SIB1 transmission. The carrier can be indicated by an ARFCN. Each entry in first list can include index(es) of one or more entries in the second list to indicate carriers associated with each SIB1 request configuration. The SIB1 request configuration for a cell is the SIB1 request configuration corresponding to the carrier of that cell.

In some embodiments, Cell A may signal a first list of one or more SIB1 request configurations and a second list of one or more cell identities (e.g., a PCI or global cell identity) supporting on demand SIB1 transmission. Each entry in the second list can include an index of an entry in the first list to indicate SIB1 request configurations for each cell.

In some embodiments, Cell A may signal a first list of one or more SIB1 request configurations and a second list of one or more cell identities (e.g., a PCI or global cell identity) supporting on demand SIB1 transmission. Each entry in the first list can include index(es) of one or more entries in the second list to indicate cells associated with each SIB1 request configuration.

In some embodiments, Cell A may signal a first list of one or more SIB1 request configurations and a second list of one or more [carrier, cell identity] pairs supporting on demand SIB1 transmission. Each entry in second list can include an index of an entry in first list to indicate SIB1 request configurations for each carrier. The SIB1 request configuration for a cell is the SIB1 request configuration corresponding to the [carrier, cell identity] pair of that cell.

In some embodiments, Cell A may signal a first list of one or more SIB1 request configurations and a second list of one or more [carrier, cell identity] pairs supporting on demand SIB1 transmission. Each entry in first list can include index(es) of one or more entries in second list to indicate [carrier, cell identity] pairs associated with each SIB1 request configuration. The SIB1 request configuration for a cell is the SIB1 request configuration corresponding to carrier of that cell.

In some embodiments, Cell A may signal a list of one or more SIB1 request configurations. Each entry in the list includes at least one of cell identity and carrier (ARFCN) associated with the SIB1 request configuration. Each entry can be associated with multiple cell identities and/or carriers (ARFCNs).

In some embodiments, Cell A may signal a list of one or more SIB1 request configurations. Each entry in the list includes an area ID. The area ID can be a TA/RAN area/SI area ID or a new area type (e.g., on demand SIB1 area ID). Each cell is associated with an area ID and that be broadcast by the cell. Alternately, mapping between cells and the area ID can be signaled by Cell A. The SIB1 request configuration associated with an area ID is used in all cells associated with same area ID.

In some embodiments, Cell A may signal a SIB1 request configuration. This SIB1 request configuration is used in all cells associated with the same area ID as the area ID of Cell A. The area ID can be a TA/RAN area/SI area ID or a new area type (e.g., on demand SIB1 area ID).

At operation 830, while the UE is camped on Cell A, the UE determines a target cell (e.g., Cell B) for cell reselection. Cell B is the target cell for reselection according to cell reselection criteria (intra frequency or inter frequency) based on cell reselection parameters obtained from Cell A. Before cell reselection to Cell B, the UE may acquire a SIB1 request configuration of Cell B from Cell A, if the UE has not yet acquired the same (or if the UE has acquired the SIB1 request configuration previously but the SIB1 request configuration is not valid).

At operation 840, before cell reselection to Cell B, the UE acquires SIB1 for Cell B as follows (note that this SIB1 request procedure can also be applied for cases [e.g., during handover, SI update, acquired SIB1's validity timer expires, SIB1 acquisition for on demand OSI etc.] other than cell reselection):

In some embodiments, if a SIB1 request configuration is available for Cell B, the UE initiates the SIB1 request procedure and the UE sends/transmits a SIB1 request to Cell B, the UE does not check whether SIB1 is currently being transmitted or provided on demand (i.e., based on request) before initiating the SIB1 request procedure or before sending the SIB1 request.

Alternately, in some embodiments, if a SIB1 request configuration is available for Cell B, the UE initiates the SIB1 request procedure and the UE sends/transmits a SIB1 request to Cell B, the UE does not check whether the SIB1 is currently being transmitted or provided on demand (i.e., based on request) before initiating the SIB1 request procedure or before sending the SIB1 request. The UE monitors for SIB1 (i.e., monitors a PDCCH for SIB1 in PDCCH monitoring occasions for SIB1) while the SIB1 request procedure is ongoing and aborts the SIB1 request procedure if SIB 1 is obtained.

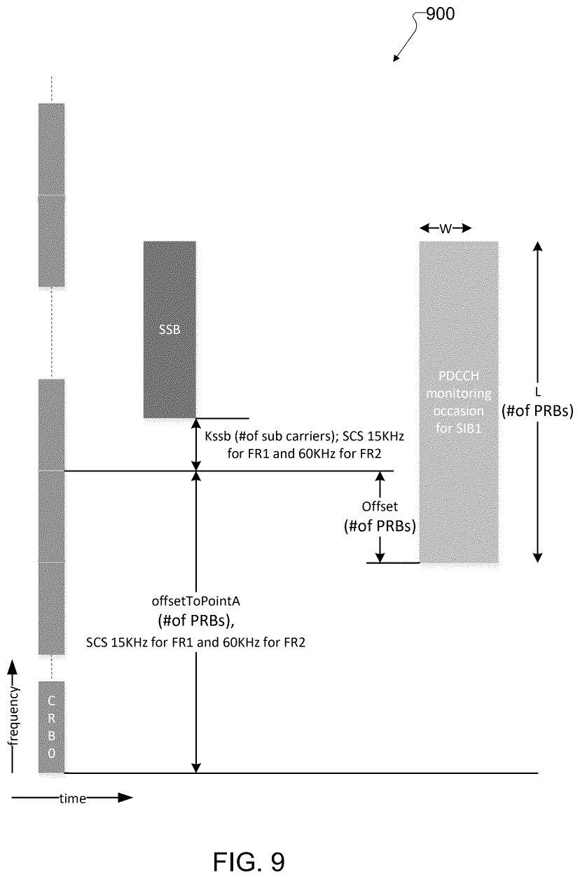

Alternately, in some embodiments, the UE first determine if SIB1 is currently being transmitted (or periodically broadcast) in Cell B or if SIB1 is provided upon a SIB1 request. If SIB1 is provided upon a SIB1 request, the UE initiates the SIB1 request procedure and UE sends/transmits a SIB1 request to Cell B.
In some embodiments, the UE may determine this based on information in the MIB of Cell B, the UE acquires the MIB of Cell B. The MIB is carried in the PBCH of an SSB transmitted by Cell B which the UE acquires for the MIB.
   The MIB may indicate whether SIB1 is currently being transmitted (or periodically broadcast) in Cell B or if SIB1 is provided upon a SIB1 request.
   The MIB may indicate the SIB1 is not transmitted in the cell or transmitted in the cell. If the MIB indicates that SIB1 is not transmitted in the cell and the UE has a SIB1 request configuration, the UE assumes that SIB1 is provided upon a SIB1 request. If the MIB indicates that SIB1 is transmitted in the cell, the UE assumes that SIB1 is being currently transmitted in the cell.
   The MIB may indicate a search space zero and CORESET 0. If the search space zero and CORESET zero are provided in the MIB, the UE assumes that SIB1 is being currently transmitted.
   The MIB may indicate 4 least significant bits (LSBs) of a subcarrier offset (k_{SSB}) by including a field ssb-SubcarrierOffset. For frequency range FR2, the k_{SSB} is ssb-SubcarrierOffset. For frequency range FR1, the k_{SSB} is 5 bits wherein ssb-SubcarrierOffset indicates 4 LSBs of k_{SSB} and PBCH payload indicate 1 most significant bit (MSB). The subcarrier offsets may be similar as shown in FIG. 9.
   For FR1, if the determined k_{SSB} based on ssb-SubcarrierOffset and the PBCH payload is set to a specific value, wherein the specific value can be pre-defined, the specific value can be one of values>=24; and the SIB1 request configuration is available for Cell B: the UE considers that SIB1 is provided upon SIB1 request and the UE transmits a SIB1 request.
   For FR2, if the determined k_{SSB} based on ssb-SubcarrierOffset is set to a specific value, wherein the specific value can be pre-defined, the specific value can be one of values>=12; and the SIB1 request configuration is available for Cell B: the UE considers that SIB1 is provided upon SIB1 request and the UE transmits a SIB1 request.
Alternately, in some embodiments, Cell A can indicate whether SIB1 is currently being transmitted (or periodically broadcast) in Cell B or if SIB1 is provided upon SIB1 request. The UE may obtain this information from Cell A.

FIG. 9 illustrates a graph 900 showing example offsets according to embodiments of the present disclosure. The embodiment of offsets of FIG. 9 are for illustration only. Different embodiments of offset could be used without departing from the scope of this disclosure. Although FIG. 9 illustrates one example graph 900, various changes may be made to FIG. 9. For example, various changes to the offsets could be made according to particular needs.

At operation 850, upon transmitting the SIB1 request, the UE determines the PDCCH monitoring occasions for SIB1 as follows:

In some embodiments, the UE may receive PDCCH-ConfigSIB1 (or search space zero and CORESET zero) of Cell B from Cell A. UE may receive this information as part of SIB1 request configuration. Search space zero (4 bit info) and CORESET zero (4 bit info) indicate the PDCCH monitoring occasions for SIB1. The UE may also receive ssb-SubcarrierOffset or k_{SSB} of Cell B from Cell A. This k_{SSB} (or k_{SSB} based on ssb-SubcarrierOffset) is used to determine the start of a common resource block (CRB). This K_{SSB} (or k_{SSB} based on ssb-SubcarrierOffset) indicates the offset between the start of an SSB of Cell B and the start of the CRB as shown in FIG. 9 in the frequency domain. CORESET zero indicates the number of PRBs and # of symbols of the PDCCH monitoring occasion. CORESET zero also indicates the offset between the CRB (in the frequency domain) and the start of the physical resource block (PRB) of the PDCCH monitoring occasion in the frequency domain as shown in FIG. 9.

In some embodiments, the UE may receive a configuration of PDCCH monitoring occasions for SIB1 of Cell B from Cell A. UE may receive this information as part of a SIB1 request configuration. The UE may also receive ssb-SubcarrierOffset or k_{SSB} of Cell B from Cell A. This k_{SSB} (or k_{SSB} based on ssb-SubcarrierOffset) is used to determine the start of a CRB. This k_{SSB} (or k_{SSB} based on ssb-SubcarrierOffset) indicates the offset between the start of an SSB and the start of the CRB as shown in FIG. 9. The UE may also receive number of PRBs and # of symbols of PDCCH monitoring occasion. The UE may also receive an offset between the CRB (in the frequency domain) and start of a PRB of a PDCCH monitoring occasion in the frequency domain as shown in FIG. 9.

Alternately, in some embodiments, after transmitting a SIB1 request to Cell B, the UE acquires the MIB of Cell B. The MIB includes PDCCHConfigSIB1 indicating search space zero and CORESET zero of Cell B. A gNB of Cell B includes PDCCHConfigSIB1 indicating search space zero and CORESET zero in the MIB after receiving the SIB1 request. The UE receives ssb-SubcarrierOffset or k_{SSB} in the MIB. This k_{SSB} (or k_{SSB} based on ssb-SubcarrierOffset) is used to determine the start of a CRB. This k_{SSB} (or k_{SSB} based on ssb-SubcarrierOffset) indicates an offset between the start of an SSB and the start of the CRB as shown in FIG. 9. CORESET zero indicates the number of PRBs and # of symbols of a PDCCH monitoring occasion. CORESET zero also indicates an offset between the CRB (in the frequency domain) and the start of a PRB of the PDCCH monitoring occasion in the frequency domain as shown in FIG. 9.

Alternately, in some embodiments, after receiving an acknowledgement (ACK) for the SIB1 request transmitted to Cell B, the UE acquires the MIB of Cell B. The MIB includes PDCCHConfigSIB1 indicating search space zero and CORESET zero of Cell B. A gNB of Cell B includes PDCCHConfigSIB1 indicating search space zero and CORESET zero in the MIB after receiving the SIB1 request. The UE receive ssb-SubcarrierOffset or k_{SSB} in the MIB. This k_{SSB} (or k_{SSB} based on ssb-SubcarrierOffset) is used to determine the start of a CRB. This k_{SSB} (or k_{SSB} based on ssb-SubcarrierOffset) indicates an offset between the start of an SSB and start of the CRB as shown in FIG. 9. CORESET zero indicates the number of PRBs and # of symbols of a PDCCH monitoring occasion. CORESET zero also indicates an offset between the CRB (in the frequency domain) and start of a PRB of the PDCCH monitoring occasion in the frequency domain as shown in FIG. 9.

Alternately, in some embodiments, the MIB of Cell B always indicates search space zero and CORESET zero of Cell B (i.e., even when SIB1 is provided on demand). Search space zero and CORESET zero indicate the PDCCH monitoring occasions for SIB1. The UE may receive ssb-SubcarrierOffset or k_{SSB} of Cell B from Cell A. This k_{SSB} (or k_{SSB} based on ssb-SubcarrierOffset) is used to determine the start of a CRB. This k_{SSB} (or k_{SSB} based on ssb-SubcarrierOffset) indicates an offset between the start of an SSB and start of the CRB.

Alternately, in some embodiments, the MIB of Cell B always indicates search space zero and CORESET zero of Cell B (i.e., even when SIB1 is provided on demand). Search space zero and CORESET zero indicate the PDCCH monitoring occasions for SIB1. The UE also receives ssb-SubcarrierOffset or k_{SSB} in the MIB. This k_{SSB} (or k_{SSB} based on ssb-SubcarrierOffset) is used to determine the start of a CRB. This k_{SSB} (or k_{SSB} based on ssb-SubcarrierOffset) indicates an offset between the start of an SSB and start of the CRB.

Alternately, in some embodiments, after transmitting a SIB1 request to Cell B, the UE receives an ACK (e.g., a random access response [RAR]) for the SIB1 request. The ACK (e.g., RAR) for the SIB1 request includes PDCCHConfigSIB1 indicating search space zero and CORESET zero of Cell B. The UE receives ssb-SubcarrierOffset or k_{SSB} in the ACK (e.g., RAR) for the SIB1 request. This k_{SSB} (or k_{SSB} based on ssb-SubcarrierOffset) is used to determine the start of a CRB. This k_{SSB} (or k_{SSB} based on ssb-SubcarrierOffset) indicates an offset between the start of an SSB and start of the CRB. CORESET zero indicates a number of PRBs and # of symbols of a PDCCH monitoring occasion. CORESET zero also indicates an offset between the CRB (in the frequency domain) and start of a PRB of the PDCCH monitoring occasion in the frequency domain.

In some embodiments, the UE acquires an SSB and MIB from Cell B. For FR2, k_{SSB} equals 12/13/14/15 (or >=12) in the MIB or is indicated by the MIB of Cell B and the SIB1 request configuration availability for Cell B (e.g., from Cell A or pre configuration) indicates to the UE that SIB1 is provided upon a SIB1 request. The UE transmits a SIB1 request. The UE reacquires the SSB/MIB. The k_{SSB}, search space zero and CORESET zero to acquire SIB1 are obtained by the UE by acquiring the MIB again after transmitting the SIB1 request (or after receiving an ACK for the SIB1 request). After receiving the SIB1 request, Cell B transmits a new MIB with k_{SSB}, search space zero and CORESET zero to acquire SIB1.

In some embodiments, the UE acquires an SSB and MIB from Cell B. For FR1, k_{SSB}>=23 in the MIB or is indicated by the MIB of Cell B and the SIB1 request configuration availability indicates to the UE that SIB1 is provided upon a SIB1 request. The UE transmits a SIB1 request. The UE reacquires the SSB/MIB. The k_{SSB}, search space zero and CORESET zero to acquire SIB1 are obtained by the UE by acquiring the MIB again after transmitting the SIB1 request (or after receiving an ACK for the SIB1 request). After receiving the SIB1 request, Cell B transmits a new MIB with k_{SSB}, search space zero and CORESET zero to acquire SIB1.

In some embodiments, the UE acquires an SSB and MIB from Cell B. For FR2, k_{SSB} equals 14 in the MIB or is indicated by the MIB of Cell B and the SIB1 request configuration availability for Cell B (e.g., from Cell A or pre configuration) indicates to the UE that SIB1 is provided upon a SIB1 request. The UE transmits a SIB1 request. The UE acquires SIB1 after transmitting the SIB1 request (or after receiving an ACK for the SIB1 request). The search space zero and CORESET zero to acquire SIB1 are obtained by the UE from the MIB of Cell B. The k_{SSB} to acquire SIB1 is obtained from Cell A (e.g., in a SIB1 request configuration). The UE does not need to reacquire the MIB after transmitting the SIB1 request.

In some embodiments, the UE acquires an SSB and MIB from Cell B. For FR2, k_{SSB} equals 14 in the MIB or is indicated by the MIB of Cell B and the SIB1 request configuration availability for Cell B (e.g., from Cell A or pre configuration) indicates to the UE that SIB1 is provided upon a SIB1 request. The k_{SSB}, search space zero and CORESET zero to acquire SIB1 are obtained by the UE from the MIB of Cell B. The UE transmits a SIB1 request. The UE acquires SIB1 after transmitting SIB 1 request (or after receiving an ACK for the SIB1 request). The UE does not need to reacquire the MIB after transmitting the SIB1 request.

In some embodiments, The UE acquires an SSB and MIB from Cell B. For FR2, k_{SSB} equals 14 in the MIB or is indicated by the MIB of Cell B and the SIB1 request configuration availability for Cell B (e.g., from Cell A or pre configuration) indicates to the UE that SIB1 is provided upon a SIB1 request. The k_{SSB}, search space zero and CORESET zero to acquire SIB1 are obtained by the UE from Cell A (e.g., in a SIB1 request configuration). The UE transmits a SIB1 request. The UE acquires SIB1 after transmitting the SIB1 request (or after receiving and ACK for the SIB1 request). The UE does not need to reacquire MIB after transmitting SIB1 request.

In some embodiments, the UE acquires an SSB and MIB from Cell B. For FR2, k_{SSB} equals 12/13/15 in the MIB or is indicated by the MIB of Cell B and the SIB1 request configuration availability for Cell B (e.g., from Cell A or pre configuration) indicates to the UE that SIB1 is provided upon a SIB1 request. The UE transmits a SIB1 request. The UE acquires SIB1 after transmitting the SIB1 request (or after receiving an ACK for the SIB1 request). The search space zero and CORESET zero to acquire SIB1 are obtained by the UE from the MIB of Cell B. The k_{SSB} to acquire SIB1 is obtained from Cell A (e.g., in a SIB1 request configuration). The UE does not need to reacquire the MIB after transmitting SIB1 request.

In some embodiments, the UE acquires an SSB and MIB from Cell B. For FR2, k_{SSB} equals 12/13/15 in the MIB or is indicated by the MIB of Cell B and the SIB1 request configuration availability for Cell B (e.g., from Cell A or pre configuration) indicates to the UE that SIB1 is provided upon a SIB1 request. The k_{SSB}, search space zero and CORESET zero to acquire SIB1 are obtained by the UE from the MIB of Cell B. The UE transmits a SIB1 request. The UE acquires SIB1 after transmitting the SIB1 request (or after receiving an ACK for the SIB1 request). The UE does not need to reacquire the MIB after transmitting SIB1 request.

In some embodiments, the UE acquires an SSB and MIB from Cell B. For FR2, k_{SSB} equals 12/13/15 in the MIB or is indicated by the MIB of Cell B and the SIB1 request configuration availability for Cell B (e.g., from Cell A or pre configuration) indicates to the UE that SIB1 is provided upon a SIB1 request. The k_{SSB}, search space zero and CORESET zero to acquire SIB1 are obtained by the UE from Cell A (e.g., in a SIB1 request configuration). The UE transmits the SIB1 request. The UE acquires SIB1 after transmitting the SIB1 request (or after receiving an ACK for the SIB1 request). The UE does not need to reacquire the MIB after transmitting SIB1 request.

At operation 860, the UE monitors the PDCCH monitoring occasions for on demand SIB1 transmission as follows:

In some embodiments, if acknowledgment for the SIB1 request is received by the UE, the UE immediately (i.e., from the first available PDCCH monitoring occasion) starts to monitor PDCCH monitoring occasions for SIB1. Note that the UE may stop monitoring once the SIB1 is received (or the PDCCH for SIB1 is received/successfully decoded).

In some embodiments, if acknowledgment for the SIB1 request is received by the UE in an Nth SIB1 transmission period, the UE monitors PDCCH monitoring occasions for SIB1 in an N+1th transmission period (or P consecutive transmission periods starting from the N+1th transmission period). Note that the UE may stop monitoring once the SIB1 is received (or the PDCCH for SIB1 is received/successfully decoded). The transmission period can be 160 ms or 20 ms or any configurable value. The transmission period can be a SI modification period. The Transmission period starts from system frame number (SFN) 0. P can be configured by a gNB (e.g., in the SIB1 request configuration, SI or an RRC message) or can be pre-defined.

In some embodiments, if acknowledgment for the SIB1 request is received by the UE in an Nth SIB1 transmission period, the UE monitors PDCCH monitoring occasions for SIB1 in the Nth and N+1th transmission periods. Note that UE may stop monitoring once the SIB1 is received (or the PDCCH for SIB1 is received/successfully decoded). The transmission period can be 160 ms or 20 ms or any configurable value. The transmission period starts from SFN 0. The transmission period can be a SI modification period.

In some embodiments, if acknowledgment for the SIB1 request is received by the UE in an Nth SIB1 transmission period, the UE monitors a PDCCH monitoring occasions for SIB1 in the N+Kth transmission period (or P consecutive transmission periods starting from the N+Kth transmission period). Note that the UE may stop monitoring once the SIB1 is received (or the PDCCH for SIB1 is received/successfully decoded). The transmission period can be 160 ms or 20 ms or any configurable value. The transmission period starts from SFN 0. K can be configured by a gNB (e.g., in SIB1 request configuration, SI or RRC message) or can be pre-defined. P can be configured by the gNB (e.g., in a SIB1 request configuration, SI or RRC message) or can be pre-defined. The transmission period can be a SI modification period.

In some embodiments, if acknowledgment for the SIB1 request is received by the UE, the UE starts a timer. While the timer is running, the UE monitors PDCCH monitoring occasions for SIB1. The UE stops the timer once the SIB1 is received (or PDCCH for SIB1 is received/successfully decoded).

In some embodiments, if acknowledgment for the SIB1 request is received by the UE, the UE monitors PDCCH monitoring occasions for SIB1 in a time window, where the size of window is configured by a gNB and the window starts at the first slot/symbol/subframe/frame where (or after the) the SIB1 request ack is received. Note that the UE may stop monitoring once the SIB1 is received (or the PDCCH for SIB1 is received/successfully decoded).

In some embodiments, upon transmitting the SIB1 request, the UE immediately (i.e., from the first available PDCCH monitoring occasion) starts to monitor PDCCH monitoring occasions for SIB1. Note that the UE may stop monitoring once the SIB1 is received (or the PDCCH for SIB1 is received/successfully decoded).

In some embodiments, if a SIB1 request is transmitted by UE in an Nth SIB1 transmission period, the UE monitors PDCCH monitoring occasions for SIB1 in an N+1th transmission period (or P consecutive transmission periods starting from the N+1th transmission period). Note that the UE may stop monitoring once the SIB1 is received (or the PDCCH for SIB1 is received/successfully decoded). The transmission period can be 160 ms or 20 ms or any configurable value. The transmission period starts from SFN 0. P can be configured by a gNB (e.g., in a SIB1 request configuration, SI or an RRC message) or can be pre-defined. The transmission period can be a SI modification period.

In some embodiments, if a SIB1 request is transmitted by UE in an Nth SIB1 transmission period, the UE monitors PDCCH monitoring occasions for SIB1 in the Nth and N+1th transmission periods. Note that the UE may stop monitoring once the SIB1 is received (or the PDCCH for SIB1 is received/successfully decoded). The transmission period can be 160 ms or 20 ms or any configurable value. The transmission period starts from SFN 0. The transmission period can be a SI modification period.

In some embodiments, if a SIB1 request is transmitted by the UE in a Nth SIB1 transmission period, the UE monitors PDCCH monitoring occasions for SIB1 in a N+Kth transmission period (or P consecutive transmission periods starting from the N+Kth transmission period). Note that the UE may stop monitoring once the SIB1 is received (or the PDCCH for SIB1 is received/successfully decoded). The transmission period can be 160 ms or 20 ms or any configurable value. The transmission period starts from SFN 0. K can be configured by a gNB (e.g., in a SIB1 request configuration, SI or an RRC message) or can be pre-defined. P can be configured by the gNB (e.g., in a SIB1 request configuration, SI or an RRC message) or can be pre-defined. The transmission period can be a SI modification period.

In some embodiments, upon transmitting the SIB1 request, the UE starts a timer. While the timer is running, the UE monitors PDCCH monitoring occasions for SIB1. The UE stops the timer once the SIB1 (or PDCCH for SIB1 is received/successfully decoded) is received.

In some embodiments, upon transmitting the SIB1 request, the UE monitors PDCCH monitoring occasions for SIB1 in a time window, where the size of the window is configured by a gNB and the window starts at a first slot/symbol/subframe/frame after the SIB1 request is transmitted. Note that the UE may stop monitoring once the SIB1 is received (or the PDCCH for SIB1 is received/successfully decoded).

In some embodiments,
The UE acquires the MIB of a cell.
The MIB includes ssb-SubcarrierOffset Kssb information.
ssb-SubcarrierOffset Kssb indicates that this cell does not provide SIB1 (or does not transmit SIB1 periodically or provides SIB1 on demand)
If the UE supports on demand SIB1 transmission and the UE has a SIB1 request configuration for this cell (e.g., the UE may have obtained a SIB1 request configuration for this cell from another cell or this cell when the UE was earlier camped to this cell)
   The UE does not bar this cell. The UE sends a SIB1 request and if the UE is not able to acquire SIB1 after sending the request, the UE may bar the cell.
   Otherwise
The UE bars this cell as the UE is not able to acquire SIB1.

In some embodiments
The UE acquires MIB of a cell
The MIB indicates that SIB1 is not being transmitted in the cell (or the SIB is provided on demand)
The UE sends a SIB1 request
Upon transmitting the SIB1 request, the UE reacquires the MIB.
The UE acquires SIB1 if the MIB indicates that SIB1 is being transmitted in the cell. The UE monitors PDCCH monitoring occasions for SIB1 based on a search space zero and CORESET zero configuration in the MIB.

In some embodiments, the UE is camped in a cell. The UE acquires SIB1 of the cell. The UE starts a validity timer (e.g., the timer can be 3 hours or other configurable value). The acquired SIB1 is considered invalid upon expiry of this timer. Upon expiry of this timer, the UE checks if SIB1 is being transmitted in cell or being provided on demand. If provided on demand, the UE sends a SIB1 request. Upon the SIB1 request, the UE acquires SIB1 as explained herein.

In some embodiments, the UE is camped in a cell. If the UE needs to acquire/reacquire the SIB1 of this camped cell, the UE checks if it has acquired the MIB of this cell in the current MIB TTI (the MIB TTI can be 80 ms or 8 radio frames wherein the TTI is started from SFN 0). If yes, the UE checks this MIB to determine (the determination can be based on Kssb as explained earlier) whether SIB1 is provided on demand or being transmitted (or periodically transmitted in the cell). If no, the UE acquires the MIB of the camped cell and then the UE checks this MIB to determine (the determination can be based on Kssb as explained earlier) whether SIB1 is provided on demand or is being transmitted (or periodically transmitted in the cell). If SIB1 is provided on demand, the UE transmits a SIB1 request. Otherwise, the UE acquires SIB1 from the broadcast.

In some embodiments, upon receiving the SIB1 request, the cell transmits SIB1 in a time window. While SIB1 is being transmitted in this window, the cell may update the MIB to indicate that SIB1 is being transmitted. For this change of the MIB, the cell is not required to or does not send an SI change notification to UEs in the cell. In some embodiments, the cell may send an SI change notification to UEs in the cell, so that they can reacquire the MIB.

Although FIG. 8 illustrates one example procedure 800 for SIB1 acquisition, various changes may be made to FIG. 8. For example, while shown as a series of operations, various operations in FIG. 8 could overlap, occur in parallel, occur in a different order, occur any number of times, be omitted, or replaced by other operations.

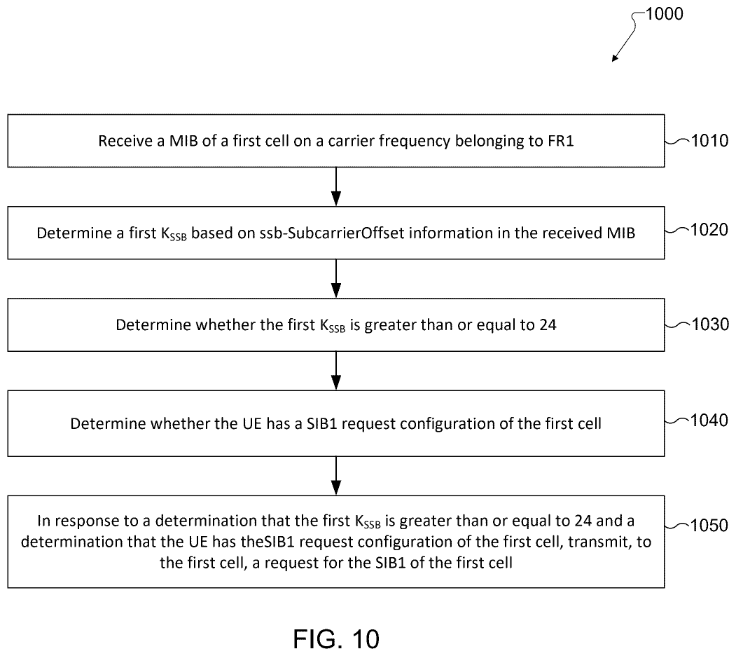

FIG. 10 illustrates an example method 1000 for SIB1 acquisition according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for SIB1 acquisition could be used without departing from the scope of this disclosure.

In the example of FIG. 10, method 1000 begins at step 1010. At step 1010, a UE (such as UE 116 of FIG. 1) receives a MIB of a first cell on a carrier frequency belonging to FR1. In some embodiments, the carrier frequency (or DL carrier frequency) of the first cell belongs to FR1 and the first cell transmits its MIB on this carrier frequency.

At step 1020, the UE determines a first K_{SSB} based on ssb-SubcarrierOffset information in the MIB received on the carrier frequency belonging to FR1. In some embodiments, the ssb-SubcarrierOffset information in the MIB of the first cell may indicate four LSBs of the first K_{SSB} and a PBCH payload of a PBCH in which the MIB of the first cell is received may indicate one MSB of the first K_{SSB}.

At step 1030, the UE determines whether the first K_{SSB} is greater than or equal to 24.

At step 1040, the UE determines whether the UE has a SIB1 request configuration of the first cell.

At step 1050, the UE in response to a determination that the first K_{SSB} is greater than or equal to 24 and a determination that the UE has the SIB1 request configuration of the first cell, transmits, to the first cell, a request for the SIB1 of the first cell.

In some embodiments, in response to a determination that the first K_{SSB} is greater than or equal to 24 and a determination that the UE does not have the SIB1 request configuration of the first cell, the UE may bar the first cell.

In some embodiments, the UE may bar the first cell when the UE fails to receive a SIB1 from the first cell after transmitting the request for the SIB1 of the first cell.

In some embodiments, the UE may receive a list of one or more SIB1 request configurations from the first cell or a second cell. Each entry in the list may include at least one of a cell identity and an ARFCN.

In some embodiments, the SIB1 request configuration of the first cell may include a second K_{SSB}, a search space zero configuration, and a control resource set 0. In these embodiments, the UE may (i) determine a PDCCH monitoring occasion in a time domain of the first cell based on the search space zero configuration in the SIB1 request configuration of the first cell, (ii) determine a start of a physical resource block of the PDCCH monitoring occasion in a frequency domain based on the control resource set zero and the second KSSB in the SIB1 request configuration of the first cell, and (iii) receive the PDCCH in the determined PDCCH monitoring occasion.

In some embodiments, the UE may monitor the PDCCH monitoring occasion for the SIB1 in a configured time window.

Although FIG. 10 illustrates one example method 1000 for SIB1 acquisition, various changes may be made to FIG. 10. For example, while shown as a series of steps, various steps in FIG. 10 could overlap, occur in parallel, occur in a different order, occur any number of times, be omitted, or replaced by other steps.

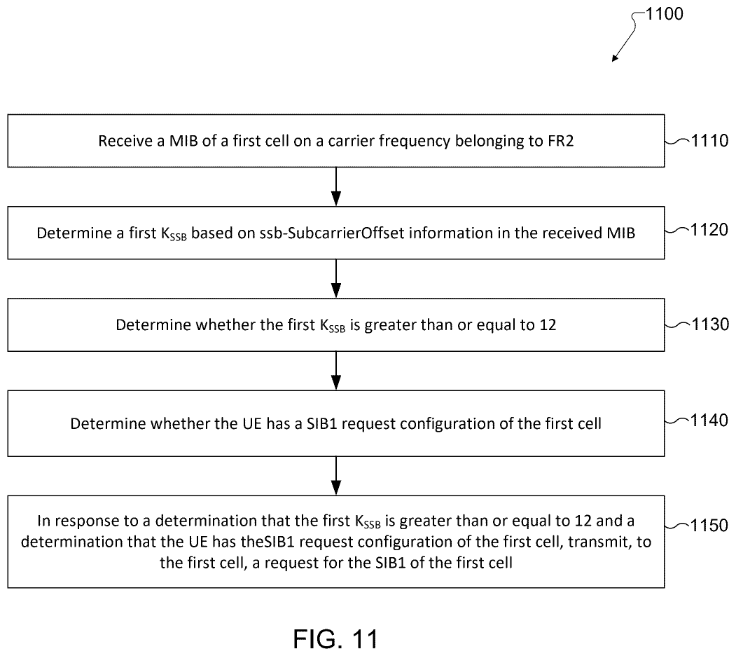

FIG. 11 illustrates an example method 1100 for SIB1 acquisition according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for SIB1 acquisition could be used without departing from the scope of this disclosure.

In the example of FIG. 11, method 1100 begins at step 1110. At step 1110, a UE (such as UE 116 of FIG. 1) receives a MIB of a first cell on a carrier frequency belonging to FR2. In some embodiments, the carrier frequency (or DL carrier frequency) of the first cell belongs to FR2 and the first cell transmits its MIB on the carrier frequency.

At step 1120, the UE determines a first K_{SSB} based on ssb-SubcarrierOffset information in the MIB received on the carrier frequency belonging to FR2. In some embodiments, the ssb-SubcarrierOffset information in the MIB of the first cell may be the first K_{SSB}.

At step 1130, the UE determines whether the first K_{SSB} is greater than or equal to 12.

At step 1140, the UE determines whether the UE has a SIB1 request configuration of the first cell.

At step 1150, the UE in response to a determination that the first K_{SSB} is greater than or equal to 12 and a determination that the UE has the SIB1 request configuration of the first cell, transmits, to the first cell, a request for the SIB1 of the first cell.

In some embodiments, in response to a determination that the first K_{SSB} is greater than or equal to 12 and a determination that the UE does not have the SIB1 request configuration of the first cell, the UE may bar the first cell. The first K_{SSB} greater than or equal to 12 can be a predefined value (e.g., 12 or 13 or 14 or 15) greater than or equal to 12.

In some embodiments, the UE may bar the first cell when the UE fails to receive a SIB1 from the first cell after transmitting the request for the SIB1 of the first cell.

In some embodiments, the UE may receive a list of one or more SIB1 request configurations from the first cell or a second cell. Each entry in the list may include at least one of a cell identity and an ARFCN.

In some embodiments, the SIB1 request configuration of the first cell may include a second K_{SSB}, a search space zero configuration, and a control resource set 0. In these embodiments, the UE may (i) determine a PDCCH monitoring occasion in a time domain of the first cell based on the search space zero configuration in the SIB1 request configuration of the first cell, (ii) determine a start of a physical resource block of the PDCCH monitoring occasion in a frequency domain based on the control resource set zero and the second KSSB in the SIB1 request configuration of the first cell, and (iii) receive the PDCCH in the determined PDCCH monitoring occasion.

In some embodiments, the UE may monitor the PDCCH monitoring occasion for the SIB1 in a configured time window.

Although FIG. 11 illustrates one example method 1100 for SIB1 acquisition, various changes may be made to FIG. 11. For example, while shown as a series of steps, various steps in FIG. 11 could overlap, occur in parallel, occur in a different order, occur any number of times, be omitted, or replaced by other steps.

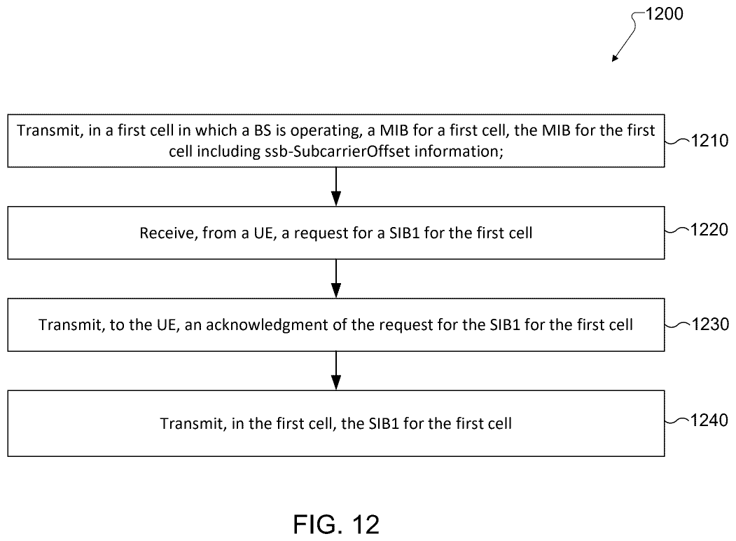

FIG. 12 illustrates another example method 1200 for SIB1 acquisition according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for SIB1 acquisition could be used without departing from the scope of this disclosure.

In the example of FIG. 12, method 1200 begins at step 1210. At step 1210, a BS (such as BS 102 of FIG. 1) transmits, in a first cell in which a BS is operating, a MIB for a first cell. The MIB for the first cell includes ssb-SubcarrierOffset information.

At step 1220, the BS receive, from a UE (such as UE 116 of FIG. 1), a request for a SIB1 for the first cell.

At step 1230, the BS transmits, to the UE, an acknowledgment of the request for the SIB1 for the first cell.

At step 1240, the BS transmits, in the first cell, the SIB1 for the first cell.

In some embodiments, the BS may transmit the MIB for the first cell on a carrier frequency belonging to FR1, ssb-SubcarrierOffset information in the MIB of the first cell may indicate four LSBs of a first K_{SSB}, a PBCH payload of a PBCH in which the MIB of the first cell is transmitted may indicate one MSB of the first K_{SSB}, and the first K_{SSB} may be greater than or equal to 24. The first K_{SSB} greater than or equal to 24 can be a predefined value (e.g., a value from 24 to 31) greater than or equal to 12.

In some embodiments, the BS may transmit the MIB for the first cell on a carrier frequency belonging to FR2, ssb-SubcarrierOffset information in the MIB of the first cell may indicate a first K_{SSB}, and the first K_{SSB} may be greater than or equal to 12.

In some embodiments, the BS may transmit a list of one or more SIB1 request configurations. Each entry in the list may include at least one of a cell identity and an ARFCN.

In some embodiments, the SIB1 request configuration of the first cell may include a second K_{SSB}, a search space zero configuration, and a control resource set 0. In these embodiments, one or more PDCCH monitoring occasions in a time domain for the SIB1 may be indicated to the UE based on the search space zero configuration in the SIB1 request configuration of the first cell, and a start of a physical resource block in a frequency domain of the one or more PDCCH monitoring occasions may be indicated to the UE based on the control resource set zero and the second K_{SSB} in the SIB1 request configuration of the first cell.

In some embodiments, the BS may transmit the SIB1 in the one or more PDCCH monitoring occasions in a configured time window.

Although FIG. 12 illustrates one example method 1200 for SIB1 acquisition, various changes may be made to FIG. 12. For example, while shown as a series of steps, various steps in FIG. 12 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive a master information block (MIB) of a first cell on a carrier frequency belonging to a first frequency range (FR1); and
a processor operably coupled to the transceiver, the processor configured to:
determine a first subcarrier offset (K_{SSB}) based on ssb-SubcarrierOffset information in the MIB received on the carrier frequency belonging to FR1;
determine whether the first K_{SSB} is greater than or equal to 24;
determine whether the UE has a system information block 1 (SIB1) request configuration of the first cell; and
in response to a determination that the first K_{SSB} is greater than or equal to 24 and a determination that the UE has the SIB1 request configuration of the first cell, cause the transceiver to transmit, to the first cell, a request for the SIB1 of the first cell.

2. The UE of claim 1, wherein:
the transceiver is further configured to receive a master information block (MIB) of the first cell on a carrier frequency belonging to a second frequency range (FR2), and
the processor is further configured to:
determine the first K_{SSB} based on the ssb-SubcarrierOffset information in the MIB received on the carrier frequency belong to FR2;
determine whether the first K_{SSB} is greater than or equal to 12;
determine whether the UE has the SIB1 request configuration of the first cell; and
in response to a determination that the first K_{SSB} is greater than or equal to 12 and a determination that the UE has the system SIB1 request configuration of the first cell, cause the transceiver to transmit, to the first cell, a request for the SIB1 of the first cell.

3. The UE of claim 1, wherein the processor is further configured to:
when the MIB of the first cell is received on the carrier frequency belonging to FR1, in response to a determination that the first K_{SSB} is greater than or equal to 24 and a determination that the UE does not have the SIB1 request configuration of the first cell, bar the first cell; and
when the MIB of the first cell is received on the carrier frequency belonging to FR2, in response to a determination that the first K_{SSB} is greater than or equal to 12 and a determination that the UE does not have the SIB1 request configuration of the first cell, bar the first cell.

4. The UE of claim 1, wherein the processor is further configured to bar the first cell when the UE fails to receive a SIB1 from the first cell after transmitting the request for the SIB1 of the first cell.

5. The UE of claim 1, wherein:
when the MIB of the first cell is received on the carrier frequency belonging to FR1, the ssb-SubcarrierOffset information in the MIB of the first cell indicates four least significant bits (LSBs) of the first K_{SSB} and a physical broadcast channel (PBCH) payload of a PBCH in which the MIB of the first cell is received indicates one most significant bit (MSB) of the first K_{SSB}, and
when the MIB of the first cell is received on the carrier frequency belonging to FR2, the ssb-SubcarrierOffset information in the MIB of the first cell is the first K_{SSB}.

6. The UE of claim 1, wherein:
the transceiver is further configured to receive a list of one or more SIB1 request configurations from the first cell or a second cell, and
each entry in the list includes at least one of a cell identity and an absolute radio-frequency channel number (ARFCN).

7. The UE of claim 6, wherein:
the SIB1 request configuration of the first cell includes a second K_{SSB}, a search space zero configuration, and a control resource set zero; and
the processor configured to:
determine a physical downlink control channel (PDCCH) monitoring occasion in a time domain of the first cell based on the search space zero configuration in the SIB1 request configuration of the first cell;
determine a start of a physical resource block of the PDCCH monitoring occasion in a frequency domain based on the control resource set zero and the second K_{SSB} in the SIB1 request configuration of the first cell; and
cause the transceiver to receive the PDCCH in the determined PDCCH monitoring occasion.

8. The UE of claim 7, wherein the transceiver is further configured to monitor the PDCCH monitoring occasion for the SIB1 in a configured time window.

9. A base station (BS) comprising:
a processor; and
a transceiver operatively coupled to the processor, the transceiver configured to:
transmit, in a first cell in which the BS is operating, a master information block (MIB) for the first cell, the MIB for the first cell including ssb-SubcarrierOffset information;
receive, from a user equipment (UE), a request for a system information block 1 (SIB1) for the first cell;
transmit, to the UE, an acknowledgment of the request for the SIB1 for the first cell; and
transmit, in the first cell, the SIB1 for the first cell.

10. The BS of claim 9, wherein:
the MIB for the first cell is transmitted on a carrier frequency belonging to a first frequency range (FR1);
ssb-SubcarrierOffset information in the MIB of the first cell indicates four least significant bits (LSBs) of a first subcarrier offset (K_{SSB});
a physical broadcast channel (PBCH) payload of a PBCH in which the MIB of the first cell is transmitted indicates one most significant bit (MSB) of the first K_{SSB}; and
the first K_{SSB} is greater than or equal to 24.

11. The BS of claim 9, wherein:
the MIB for the first cell is transmitted on a carrier frequency belonging to a second frequency range (FR2);
ssb-SubcarrierOffset information in the MIB of the first cell indicates a first subcarrier offset K_{SSB}); and
the first K_{SSB} is greater than or equal to 12.

12. The BS of claim 9, wherein:
the transceiver is further configured to transmit a list of one or more SIB1 request configurations, and
each entry in the list includes at least one of a cell identity and an absolute radio-frequency channel number (ARFCN).

13. The BS of claim 12, wherein:
the SIB1 request configuration of the first cell includes a second subcarrier offset (K_{SSB}), a search space zero configuration, and a control resource set zero;
one or more physical downlink control channel (PDCCH) monitoring occasions in a time domain for the SIB1 are indicated to the UE based on the search space zero configuration in the SIB1 request configuration of the first cell; and
a start of a physical resource block in a frequency domain of the one or more PDCCH monitoring occasions is indicated to the UE based on the control resource set zero and the second K_{SSB} in the SIB1 request configuration of the first cell.

14. The BS of claim 13, wherein to transmit the SIB1 for the first cell, the transceiver is further configured to transmit the SIB1 in the one or more PDCCH monitoring occasions in a configured time window.

15. A method of operating a user equipment (UE), the comprising:
receiving a master information block (MIB) of a first cell on a carrier frequency belonging to a first frequency range (FR1);
determining a first subcarrier offset (K_{SSB}) based on ssb-SubcarrierOffset information in the MIB received on the carrier frequency belong to FR1;
determining whether the first K_{SSB} is greater than or equal to 24;
determining whether the UE has a system information block 1 (SIB1) request configuration of the first cell; and
in response to a determination that the first K_{SSB} is greater than or equal to 24 and a determination that the UE has the SIB1 request configuration of the first cell, transmitting, to the first cell, a request for the SIB1 of the first cell.

16. The method of claim 15, further comprising:
receiving a master information block (MIB) of the first cell on a carrier frequency belonging to a second frequency range (FR2);
determining the first K_{SSB} based on the ssb-SubcarrierOffset information in the MIB received on the carrier frequency belonging to FR2;
determining whether the K_{SSB} is greater than or equal to 12;
determining whether the UE has the SIB1 request configuration of the first cell; and
in response to a determination that the K_{SSB} is greater than or equal to 12 and a determination that the UE has the system SIB1 request configuration of the first cell, transmitting, to the first cell, a request for the SIB1 of the first cell.

17. The method of claim 15, further comprising:
when the MIB of the first cell is received on the carrier frequency belonging to FR1, in response to a determination that the first K_{SSB} is greater than or equal to 24 and a determination that the UE does not have the SIB1 request configuration of the first cell, barring the first cell; and
when the MIB of the first cell is received on the carrier frequency belonging to FR2, in response to a determination that the first K_{SSB} is greater than or equal to 12 and a determination that the UE does not have the SIB1 request configuration of the first cell, barring the first cell.

18. The method of claim 15, further comprising barring the first cell when the UE fails to receive a SIB1 from the first cell after transmitting the request for the SIB1 of the first cell.

19. The method of claim 15, wherein:
when the MIB of the first cell is received on the carrier frequency belonging to FR1, the ssb-SubcarrierOffset information in the MIB of the first cell indicates four least significant bits (LSBs) of the first K_{SSB} and a physical broadcast channel (PBCH) payload of a PBCH in which the MIB of the first cell is received indicates one most significant bit (MSB) of the first K_{SSB}, and
when the MIB of the first cell is received on the carrier frequency belonging to FR2, the ssb-SubcarrierOffset information in the MIB of the first cell is the first K_{SSB}.

20. The method of claim 15 further comprising receiving a list of one or more SIB1 request configurations from the first cell or a second cell,
wherein each entry in the list includes at least one of a cell identity and an absolute radio-frequency channel number (ARFCN),
wherein the SIB1 request configuration of the first cell includes a second K_{SSB}, a search space zero configuration, and a control resource set zero; and
the method further comprises:
determining a physical downlink control channel (PDCCH) monitoring occasion in a time domain of the first cell based on the search space zero configuration in the SIB1 request configuration of the first cell;
determining a start of a physical resource block of the PDCCH monitoring occasion in a frequency domain based on the control resource set zero and the second K_{SSB} in the SIB1 request configuration of the first cell;
receiving the PDCCH in the determined PDCCH monitoring occasion; and
monitoring the PDCCH monitoring occasion for the SIB1 in a configured time window.
